(19) United States
(12) Patent Application Publication
(10) Pub. No.: US 2024/0119330 A1
(43) Pub. Date: Apr. 11, 2024

(54) Method for Determining Degree of Quantum Entanglement, Computing Device and Storage Medium

(71) Applicant: Beijing Baidu Netcom Science Technology Co., Ltd., Beijing (CN)

(72) Inventors: Zhan YU, Beijing (CN); Lei ZHANG, Beijing (CN); Xin WANG, Beijing (CN)

(21) Appl. No.: 18/323,026

(22) Filed: May 24, 2023

(30) Foreign Application Priority Data
Sep. 28, 2022 (CN) 202211196968.7

(51) Int. Cl. G06N 10/20

(52) U.S. Cl. CPC G06N 10/20

(57) ABSTRACT

Provided is a method for determining a degree of quantum entanglement, a computing device and a storage medium. The method includes: determining a target parameter value of a target adjustable parameter in a sub-circuit of a target quantum circuit, obtaining state information of the auxiliary register in the target quantum circuit, in a case of the target adjustable parameter has the target parameter value, a first input state of the auxiliary register is a preset initial state, and a second input state of the main register includes at least the first quantum state; estimating the k-order trace of the first quantum state under the first error condition based on the state information of the auxiliary register; and determining a degree of entanglement corresponding to the first quantum state based on at least the k-order trace of the first quantum state.

### CROSS-REFERENCE TO RELATED APPLICATIONS

The present application claims priority to Chinese Patent Application No. CN202211196968.7, filed with the China National Intellectual Property Administration on Sep. 28, 2022, the disclosure of which is hereby incorporated herein by reference in its entirety.

### TECHNICAL FIELD

The present disclosure relates to the field of computer technology, and in particular, to the field of quantum computing.

### BACKGROUND

Recently, the field of quantum computing has developed rapidly. From quantum algorithms and quantum hardware devices to quantum software and hardware integration platforms, quantum computing is making steady progress towards scale and practicality. More and more quantum technologies are emerging, among which quantum entanglement is one of the most important resources in quantum technologies. Quantum entanglement is a basic component of quantum computing and quantum information processing, and plays a vital role in quantum secure communications, distributed quantum computing, and other scenarios. Therefore, quantifying the degree of entanglement of a quantum system is an extremely important issue in the quantum field.

### SUMMARY

The present disclosure provides a method and apparatus for determining a degree of quantum entanglement, a device and a storage medium.

According to an aspect of the present disclosure, provided is a method for determining a degree of quantum entanglement, including: determining a target parameter value of a target adjustable parameter in a sub-circuit of a target quantum circuit; where the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; a value of k is related to the quantity of qubits (quantum bits) corresponding to the first quantum state; the target controlled unitary gate includes a first controlled unitary gate equivalent to a unitary operator U, and a second controlled unitary gate equivalent to a conjugate transpose U^{†} of the unitary operator U; the unitary operator is a unitary operator corresponding to a first quantum system; and the first quantum system is a system corresponding to the first quantum state; obtaining state information of the auxiliary register in the target quantum circuit, in a case of the target adjustable parameter has the target parameter value, a first input state of the auxiliary register is a preset initial state, and a second input state of the main register includes at least the first quantum state; estimating the k-order trace of the first quantum state under the first error condition based on the state information of the auxiliary register; and determining a degree of entanglement corresponding to the first quantum state based on at least the k-order trace of the first quantum state.

According to another aspect of the present disclosure, provided is an apparatus for determining a degree of quantum entanglement, including: a parameter processing unit configured to determine a target parameter value of a target adjustable parameter in a sub-circuit of a target quantum circuit; where the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; a value of k is related to the quantity of qubits (quantum bits) corresponding to the first quantum state; the target controlled unitary gate includes a first controlled unitary gate equivalent to a unitary operator U, and a second controlled unitary gate equivalent to a conjugate transpose U^{†} of the unitary operator U; the unitary operator is a unitary operator corresponding to a first quantum system; and the first quantum system is a system corresponding to the first quantum state; a measurement unit configured to obtain state information of the auxiliary register in the target quantum circuit, in a case of the target adjustable parameter has the target parameter value, a first input state of the auxiliary register is a preset initial state, and a second input state of the main register includes at least the first quantum state; and a determining unit configured to estimate the k-order trace of the first quantum state under the first error condition based on the state information of the auxiliary register; and determine a degree of entanglement corresponding to the first quantum state based on at least the k-order trace of the first quantum state.

According to yet another aspect of the present disclosure, provided is a computing device, including: at least one quantum processing unit (QPU); and a memory coupled to the at least one QPU and configured to store an executable instruction, where the instruction, when executed by the at least one quantum processing unit, enables the at least one quantum processing unit to execute the method described above; or, including: at least one processor; and a memory connected in communication with the at least one processor; where the memory stores an instruction executable by the at least one processor, and the instruction, when executed by the at least one processor, enables the at least one processor to execute the method described above.

According to yet another aspect of the present disclosure, provided is a non-transitory computer-readable storage medium storing a computer instruction thereon, and the computer instruction causes at least one quantum processing unit to execute the method described above, when executed by the at least one quantum processing unit; or, the computer instruction is used to cause a computer to execute the method described above.

According to yet another aspect of the present disclosure, provided is a computer program product including a computer program, and the computer program implements the method described above, when executed by at least one quantum processing unit; or, the computer program implements the method described above, when executed by a processor.

In this way, the solution of the present disclosure provides a novel quantification scheme of the entanglement degree in terms of estimating the entanglement degree corresponding to the first quantum state. Further, the solution of the present disclosure can be realized on a recent quantum computer, and thus has strong practicability; and moreover, the solution of the present disclosure can also be applied to large-scale quantum states, and thus also has scalability.

It should be understood that this summary is not intended to identify key or important features of embodiments of the present disclosure, nor is it used to limit the scope of the present disclosure. Other features of the present disclosure will be easily understood by the following description.

### BRIEF DESCRIPTION OF THE DRAWINGS

The accompanying drawings are used to better understand the present solution, and do not constitute a limitation to the present disclosure.

FIG. 1 is a first schematic diagram of an implementation flow of a method for determining a degree of quantum entanglement according to an embodiment of the present disclosure.

FIG. 2 is a second schematic diagram of an implementation flow of a method for determining a degree of quantum entanglement according to an embodiment of the present disclosure.

FIGS. 3(a) to 3(f) are schematic structural diagrams of preset parameterized quantum circuits according to embodiments of the present disclosure.

FIGS. 4(a) to 4(f) are schematic structural diagrams of target quantum circuits according to embodiments of the present disclosure.

FIG. 5 is a flowchart of an implementation of a method for training a preset parameterized quantum circuit according to an embodiment of the present disclosure.

FIG. 6 is a schematic diagram of an implementation process of a method for determining a degree of quantum entanglement in a specific embodiment according to an embodiment of the present disclosure.

FIG. 7 is a schematic structural diagram of an apparatus for determining a degree of quantum entanglement according to an embodiment of the present disclosure.

FIG. 8 is a block diagram of a computing device used to implement the method for determining the degree of quantum entanglement according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

Recently, the field of quantum computing has developed rapidly. From quantum algorithms and quantum hardware devices to quantum software and hardware integration platforms, quantum computing is making steady progress towards scale and practicality. More and more quantum technologies are emerging, among which quantum entanglement is one of the most important resources in quantum technologies. Quantum entanglement is a basic component of quantum computing and quantum information processing, and plays a vital role in quantum secure communications, distributed quantum computing, and other scenarios. Quantum entanglement is a unique phenomenon in quantum mechanics. After several particles interact with each other, since the characteristics of the respective particles have been integrated into the overall property, it is impossible at this time to describe the property of each particle, but only the property of the overall system can be described. This phenomenon is called quantum entanglement.

How to quantify the degree of entanglement of a quantum system is an extremely important issue in the quantum field. At present, the entanglement spectroscopy is a commonly used method to measure the degree of entanglement, and the difficulty of calculating the entanglement spectroscopy is to obtain the k-order trace of the quantum state. Therefore, how to efficiently estimate the k-order trace of the quantum state is very important for analyzing the degree of quantum entanglement.

Here, the entanglement spectroscopy is an important tool to characterize the property of the quantum state, and has a very wide range of applications in the field of quantum information and computing. For example, the entanglement spectroscopy can be used to detect and characterize the topological order (such as fractional quantum Hall effect) and the quantum phase transition (such as Haldane phase), and judge whether a quantum system can be efficiently simulated by detecting whether the quantum system conforms to the area law. Therefore, efficient calculation of entanglement spectroscopy is of great significance for the analysis and study of the operation law of the quantum multibody system.

Based on this, the solution of the present disclosure provides a solution for determining the degree of quantum entanglement, which can efficiently estimate and obtain the entanglement spectroscopy of the quantum state.

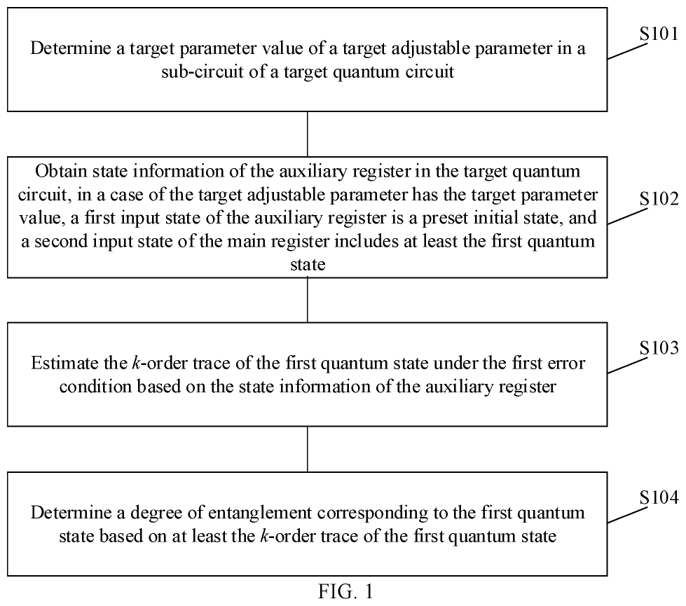

Specifically, FIG. 1 is a first schematic diagram of an implementation flow of a method for determining a degree of quantum entanglement according to an embodiment of the present disclosure; and this method is optionally applied to a quantum computing device with classical computing capability or a classical computing device with quantum computing capability, or directly applied to a classical computing device, such as a personal computer, a server, a server cluster and any other electronic device with classical computing capability, or directly applied to a quantum computer, which is not limited in the solution of the present disclosure.

Further, this method includes at least a part of the following content. As shown in FIG. 1, the quantum computing processing method includes the followings.

In step S101, a target parameter value of a target adjustable parameter in a sub-circuit of a target quantum circuit is determined.

Here, the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; and the value of k is related to the quantity of qubits corresponding to the first quantum state and is a positive integer.

Further, the target controlled unitary gate includes a first controlled unitary gate equivalent to a unitary operator U, and a second controlled unitary gate equivalent to the conjugate transpose U^{†} of the unitary operator U; that is, the first controlled unitary gate is controlled by the auxiliary register and acts on the main register, and similarly, the second controlled unitary gate is controlled by the auxiliary register and acts on the main register.

Further, the unitary operator is a unitary operator corresponding to a first quantum system; and the first quantum system is a system corresponding to the first quantum state. It can be understood that the sub-circuit is at least a part of the target quantum circuit including the target adjustable parameter, that is, the sub-circuit is a parameterized quantum circuit including the target adjustable parameter.

In step S102, state information of the auxiliary register in the target quantum circuit is obtained, in the case where the target adjustable parameter has the target parameter value, a first input state of the auxiliary register is a preset initial state, and a second input state of the main register includes at least the first quantum state.

In step S103, the k-order trace of the first quantum state under the first error condition is estimated based on the state information of the auxiliary register.

Here, the k-order trace corresponds to k-order Renyi entropy, which can measure the physical property of the first quantum system corresponding to the first quantum state, for example, measure the complexity of the first quantum system.

In step S104, a degree of entanglement corresponding to the first quantum state is determined based on at least the k-order trace of the first quantum state.

In this way, the solution of the present disclosure adopts the target quantum circuit including the auxiliary register and the main register. When the target adjustable parameter has the target parameter value, the state information of the auxiliary register is obtained by inputting the first input state and the second input state, and the k-order trace corresponding to the first quantum state is obtained, and then the degree of entanglement corresponding to the first quantum state is obtained. Thus, the solution of the present disclosure provides a novel quantification scheme of the entanglement degree in terms of estimating the entanglement degree corresponding to the first quantum state.

Further, the solution of the present disclosure can be realized on a recent quantum computer, and thus has strong practicability; and moreover, the solution of the present disclosure can also be applied to large-scale quantum states, and thus also has scalability.

In a specific example, the unitary operator is a unitary operator corresponding to the first quantum system, for example, the unitary operator is obtained based on the first quantum system; or, the unitary operator is obtained based on a total quantum system corresponding to the first quantum state.

In a specific example, the auxiliary register includes at least one qubit (quantum bit), for example, one or two or more than two qubits. Further, the quantity of qubits included in the main register is related to the quantity of qubits included in the first quantum system, for example, the quantity of qubits included in the main register is the same as the quantity of qubits included in the first quantum system.

Further, in a specific example, when the unitary operator U is obtained based on the first quantum system, the quantity of qubits included in the main register is the same as the quantity of qubits included in the first quantum system corresponding to the unitary operator U. At this time, the second input state of the main register may specifically be the first quantum state.

Here, for ease of distinction, the qubit contained in the auxiliary register may be called the auxiliary qubit. Accordingly, the qubits contained in the main register may be called main qubits.

For example, the first quantum system includes n qubits. At this time, in order to estimate the k-order trace corresponding to the first quantum state, the main register in the target quantum circuit may include n main qubits; where n is a positive integer greater than or equal to 1.

Alternatively, in another specific example, when the unitary operator U is obtained based on the total quantum system corresponding to the first quantum system, the quantity of qubits included in the main register is related to the quantity of qubits included in the total quantum system. For example, the quantity of qubits included in the main register=the quantity of qubits included in the first quantum system+the quantity of qubits included in the total quantum system. At this time, the second input state of the main register includes the first quantum state. Further, a preset initial state is also included.

In a specific example, obtaining the state information of the auxiliary register in the target quantum circuit in step S102 may specifically include: obtaining an expected value of the target quantum circuit for an observable quantity Z⊗I. Here, the expected value [symbol] Z [symbol] of the observable quantity Z⊗I is the state information of the auxiliary register.

Further, the observable quantity Z⊗I specifically refers to acting a measurement operator Z on the auxiliary register without operating the remaining qubits (that is, the main register), where I represents an identity matrix. In this way, the state information of the auxiliary register can be obtained.

In a specific example of the solution of the present disclosure, the degree of entanglement corresponding to the first quantum state may be obtained in the following way; specifically further including: obtaining (kₘₐₓ−1) traces, in the case of the value of k is 2 to a preset maximum order k^{max}; where the (Kₘₐₓ−1) traces include 2-order trace to Kₘₐₓ-order trace; and kₘₐₓ is a positive integer greater than k.

Based on this, the above step of determining the degree of entanglement corresponding to the first quantum state based on at least the k-order trace of the first quantum state, specifically includes estimating an entanglement spectroscopy corresponding to the first quantum state based on the 2-order trace to Kₘₐₓ-order trace, where the entanglement spectroscopy corresponding to the first quantum state is used to measure a degree of entanglement of a total quantum system corresponding to the first quantum system.

That is to say, the traces of k at different values are obtained in this example. Here, the k-order trace may be recorded as Rₖ. At this time, when the value of k is 2 to the preset maximum order kₘₐₓ, (Kₘₐₓ-1) traces are obtained in total, and then the entanglement spectroscopy corresponding to the first quantum state is estimated based on the (kₘₐₓ−1) traces.

Here, in practical applications, k may also take a value of 0, and at this time, the 0-order trace R₀ is obtained; k may also take a value of 1, and at this time, the 1-order trace R₁ is obtained, and R₁=1; and further, the entanglement spectroscopy corresponding to the first quantum state is estimated based on the 0-order trace to k^{max}-order trace, i.e., a total of kₘₐₓ+1 traces.

In a specific example, k is a positive integer greater than or equal to 2 and less than or equal to the dimension D of the first quantum state. The dimension D of the first quantum state is related to the quantity of qubits corresponding to the first quantum state, such as D=2ⁿ, and n is the quantity of qubits corresponding to the first quantum state, that is, the quantity of qubits included in the first quantum system corresponding to the first quantum state. Further, kₘₐₓ is a positive integer less than or equal to the dimension D of the first quantum state.

In this way, while providing a novel scheme of estimating the k-order trace, the solution of the present disclosure obtains the entanglement spectroscopy of the quantum state efficiently based on the estimated k-order trace, and provides a measurement method for quantifying the degree of entanglement between quantum systems, thus laying the foundation for solving the problem of the quantum system and promoting the development of quantum computing in industrial applications.

In a specific example, the estimated k-order trace (which may be recorded as Rₖ) corresponding to the first quantum state (which can be represented by its density matrix ρ, that is, the first quantum state ρ) and the state information (such as the expected value [symbol] Z [symbol] ) of the auxiliary register satisfy the following relationship: Rₖ:= [symbol] Z [symbol] ·2π^{k-1}

In this way, after obtaining the state information (such as the expected value [symbol] Z [symbol] ) of the auxiliary register, the k-order trace Rₖ corresponding to the first quantum state can be estimated, and this process is efficient and convenient.

In a specific example, the preset initial state may specifically be |0 [symbol] or |1 [symbol] , which is not limited in the solution of the present disclosure.

In a specific example, when the first quantum system is any subsystem in the total quantum system, the entanglement spectroscopy corresponding to the first quantum state, i.e., the entanglement spectroscopy of the total quantum system, is used to measure the degree of entanglement between the first quantum system and the second quantum system in the total quantum system; and the second quantum system is other subsystem than the first quantum system in the total quantum system.

It should be noted that the first quantum system and the second quantum system are two subsystems of the total quantum system, in other words, the total quantum system is composed of the first quantum system and the second quantum system. At this time, the estimated entanglement spectroscopy in the solution of the present disclosure can be used to measure the degree of entanglement between the two subsystems (that is, the first quantum system and the second quantum system).

It should be noted that the total quantum system and the sub-quantum system described in the solution of the present disclosure are relative concepts, in other words, the total quantum system may also be a subsystem of another larger quantum system, which is not specifically limited in the solution of the present disclosure. For example, for a larger quantum system, any two subsystems in the larger quantum system may be combined into a total quantum system, and then the solution of the present disclosure is used to estimate the degree of entanglement between the two subsystems in the total quantum system.

Further, in an example, when the target adjustable parameter has the target parameter value, the first input state of the auxiliary register is the preset initial state, and the second input state of the main register in the target quantum circuit is the first quantum state, the state information of the auxiliary register is measured, and then the k-order trace corresponding to the first quantum state under the first error condition is estimated. At this time, the entanglement spectroscopy corresponding to the first quantum state ρ_{A} is estimated based on the k-order trace corresponding to the first quantum state (may also be denoted as ρ_{A}, in order to distinguish it from the second quantum state), and at this time, the entanglement spectroscopy corresponding to the first quantum state ρ_{A} can be used to measure the degree of entanglement between the first quantum system and the second quantum system in the total quantum system.

In another example, when the target adjustable parameter has the target parameter value, the first input state of the auxiliary register is the preset initial state, and the second input state of the main register in the target quantum circuit is the second quantum state of the second quantum system, the state information of the auxiliary register is measured, and then the k-order trace corresponding to the second quantum state under the first error condition is estimated. At this time, the entanglement spectroscopy corresponding to the second quantum state ρ_{B} is estimated based on the k-order trace corresponding to the second quantum state (may also be denoted as ρ_{B}, in order to distinguish it from the first quantum state), and at this time, the entanglement spectroscopy corresponding to the second quantum state ρ_{B} can be used to measure the degree of entanglement between the first quantum system and the second quantum system in the total quantum system.

Here, it can be understood that the entanglement spectroscopy described in the solution of the present disclosure is the property of the quantum state of the total quantum system. For example, for the total quantum system formed by the first quantum system A and the second quantum system B, the entanglement spectroscopy described in the solution of the present disclosure at this time may be the property of the bipartite quantum state of the total quantum system. Based on this, both the entanglement spectroscopy obtained based on the first quantum state ρ_{A} and the entanglement spectroscopy obtained based on the second quantum state ρ_{B} characterize the entanglement spectroscopy corresponding to the bipartite quantum state, so the entanglement spectroscopy corresponding to the first quantum state ρ_{A} is the same as the entanglement spectroscopy corresponding to the second quantum state ρ_{B}.

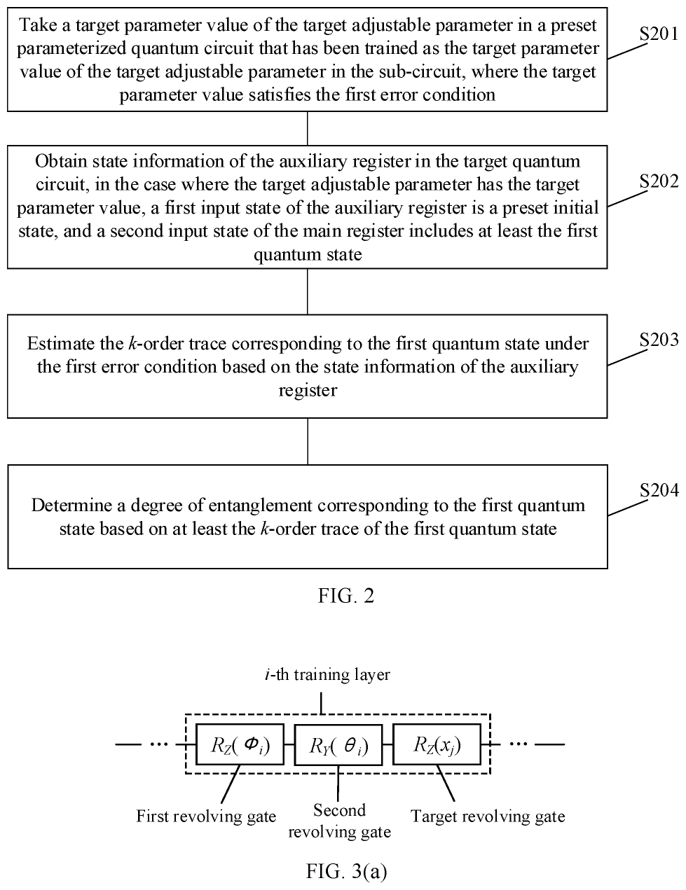

FIG. 2 is a second schematic diagram of an implementation flow of a method for determining a degree of quantum entanglement according to an embodiment of the present disclosure. This method may optionally be applied to a quantum computing device with classical computing capability or a classical computing device with quantum computing capability, or directly applied to a classical computing device, such as a personal computer, a server, a server cluster and any other electronic device with classical computing capability, or directly applied to a quantum computer, which is not limited in the solution of the present disclosure.

It can be understood that the relevant content of the method shown in FIG. 1 described above may also be applied to this example, and the relevant content will not be repeated in this example.

Further, this method includes at least a part of the following content. Specifically, as shown in FIG. 2, this method includes the followings.

In step S201, a target parameter value of the target adjustable parameter in a preset parameterized quantum circuit that has been trained is taken as the target parameter value of the target adjustable parameter in the sub-circuit, where the target parameter value satisfies the first error condition.

That is to say, the preset parameterized quantum circuit contains the target adjustable parameter, so the target parameter value of the target adjustable parameter in the preset parameterized quantum circuit that has been trained is taken as the target parameter value of the target adjustable parameter in the sub-circuit. In other words, in this example, the target parameter value of the target adjustable parameter in the sub-circuit may be obtained by training other parameterized quantum circuits.

It can be understood that the relevant description of the sub-circuit and the target quantum circuit in this example may refer to the above description, which will not be repeated here.

It should be noted that the preset parameterized quantum circuit may also contain other adjustable parameters, which are not specifically limited in the solution of the present disclosure, as long as the preset parameterized quantum circuit contains the target adjustable parameter required by the sub-circuit.

Further, the preset parameterized quantum circuit that has been trained is used to simulate an objective function ƒ(x). The objective function ƒ(x) is used to characterize a correlation between the order k and an independent variable x; where the order k is less than the dimension D of the first quantum state, that is, a positive integer greater than or equal to 2 and less than or equal to the dimension D of the first quantum state; and the dimension D of the first quantum state is related to the quantity of qubits corresponding to the first quantum state, such as D=2ⁿ, and n is the quantity of qubits corresponding to the first quantum state, that is, the quantity of qubits included in the first quantum system.

Further, the target quantum circuit is obtained by: taking a qubit in the preset parameterized quantum circuit as the auxiliary register, and expanding the preset parameterized quantum circuit to obtain the main register; and at the same time, replacing a first target revolving gate acting on the auxiliary register in the preset parameterized quantum circuit by the first controlled unitary gate, and replacing a second target revolving gate acting on the auxiliary register in the preset parameterized quantum circuit by the second controlled unitary gate. That is to say, the target quantum circuit is obtained by extending the preset parameterized quantum circuit.

Here, a first rotation parameter of the first target revolving gate and a second rotation parameter of the second target revolving gate are both the independent variable x of the objective function ƒ(x).

Further, the sub-circuit contains at least some circuits in the preset parameterized quantum circuit except the first target revolving gate and the second target revolving gate; where the first target revolving gate and the second target revolving gate may be collectively referred to as the target revolving gate. In this case, the sub-circuit contains at least some circuits in the preset parameterized quantum circuit except the target revolving gate.

It can be understood that the target quantum circuit is obtained by extending the preset parameterized quantum circuit, so the sub-circuit may also be understood to be obtained on the basis of the preset parameterized quantum circuit and contain the partial circuit structure corresponding to the target adjustable parameter in the preset parameterized quantum circuit, thus laying the foundation for obtaining the target parameter value of the target adjustable parameter of the sub-circuit by training the preset parameterized quantum circuit.

In step S202, state information of the auxiliary register in the target quantum circuit is obtained, in the case where the target adjustable parameter has the target parameter value, a first input state of the auxiliary register is a preset initial state, and a second input state of the main register includes at least the first quantum state.

In step S203, the k-order trace corresponding to the first quantum state under the first error condition is estimated based on the state information of the auxiliary register.

In step S204, a degree of entanglement corresponding to the first quantum state is determined based on at least the k-order trace of the first quantum state.

It can be understood that the preset parameterized quantum circuit has a simpler circuit structure than the target quantum circuit, so the way of obtaining the target parameter value of the target adjustable parameter by training the preset parameterized quantum circuit can reduce the calculation amount effectively, laying the foundation for efficiently solving the degree of entanglement corresponding to the first quantum state.

Further, in practical applications, the preset parameterized quantum circuit may also be obtained by simulation in a classical computing device. Accordingly, the step of obtaining the target parameter value of the target adjustable parameter through training may also be realized in the classical computing device, so the way of obtaining the target parameter value of the target adjustable parameter in the solution of the present disclosure may not occupy the quantum computing resources, thus reducing the computing cost effectively while laying the foundation for efficiently estimating the degree of entanglement corresponding to the first quantum state.

Moreover, the solution of the present disclosure does not impose any limitation on the first quantum state. In other words, the k-order trace of any quantum state may be estimated, and then the entanglement spectroscopy may be estimated to thereby measure the degree of entanglement of the quantum state. The universality is strong. At the same time, the solution of the present disclosure may also be realized on a recent quantum computer, and has strong practicability; and moreover, the solution of the present disclosure may also be applied to large-scale quantum states, and thus also has scalability. To sum up, the solution of the present disclosure has high efficiency, practicability and scalability.

In a specific example, the function analysis method may also be used to obtain the target parameter value of the target adjustable parameter; and specifically, the target Fourier series F(x) of the objective function is obtained, where the target Fourier series F(x) is a Fourier series approximating the objective function within the objective definition domain. Further, other Fourier series are obtained based on the target Fourier series F(x), such as other Fourier series P(x) and Q(x), where

$$P ( x ) = \sqrt{\frac{1 + F ( x )}{2}} ; Q ( x ) = \sqrt{\frac{1 - F ( x )}{2}} .$$

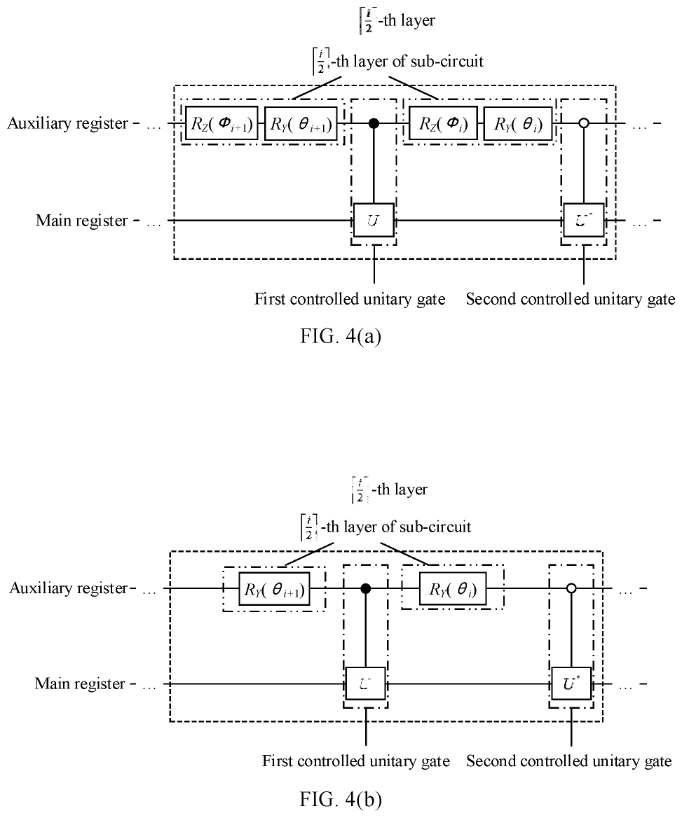

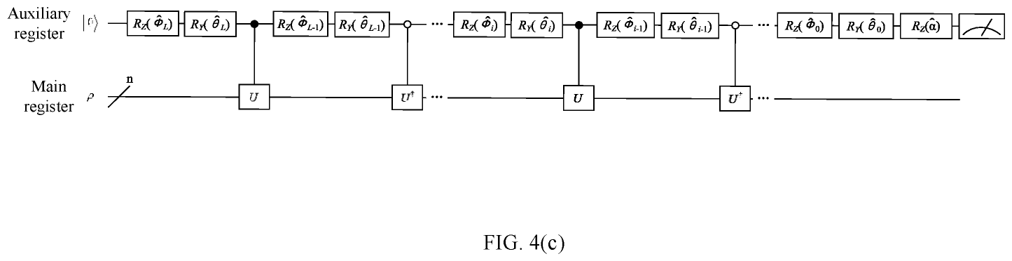

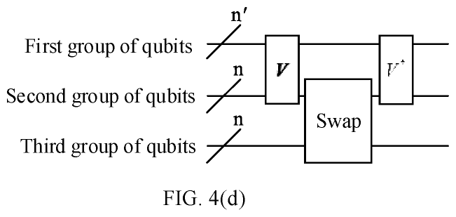

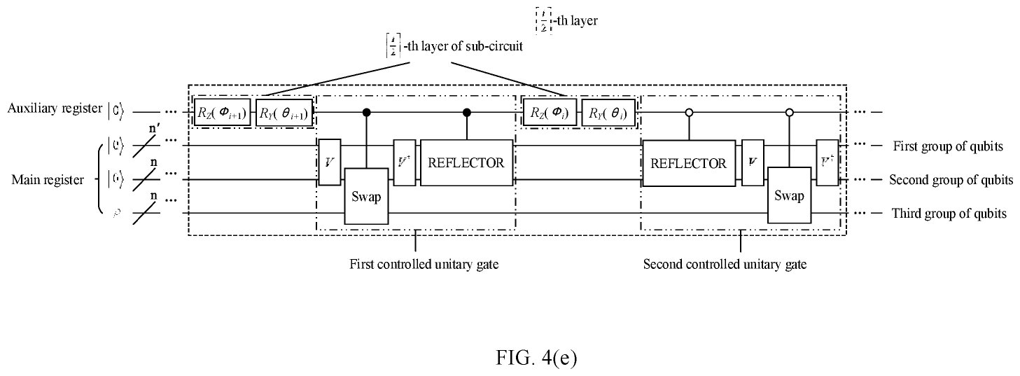

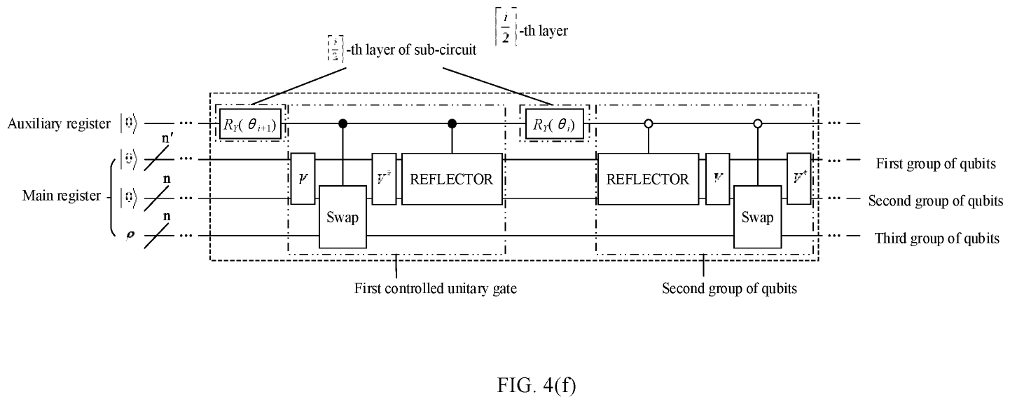

Based on the preset relationship, the target parameter value of the target adjustable parameter may be obtained; for example, for the target quantum circuit shown in FIG. 4(c) (the target quantum circuit will be illustrated later, and will not be repeated here), the preset relationship may be specifically:

$$[ \begin{matrix}P ( x ) & - Q ( x ) \\ {Q}^{*} ( x ) & {P}^{*} ( x )\end{matrix} ] = {R}_{Z} ( α ) {R}_{Y} ( {θ}_{0} ) {R}_{Z} ( {ϕ}_{0} ) {\prod }_{i = 1}^{L} {R}_{Z} ( x ) {R}_{Y} ( {θ}_{i} ) {R}_{Z} ( {ϕ}_{i} ) .$$

Here, Q*(x) is the complex conjugate of Q(x), and P*(x) is the complex conjugate of P(x).

In this way, the amount of calculation can be effectively reduced, laying the foundation for efficiently estimating the degree of entanglement corresponding to the first quantum state.

It can be understood that, in practical applications, any trigonometric polynomial that can approximate the objective function with a certain precision may be used to optimize and obtain the optimal parameter value of the adjustable target parameter, which is not specifically limited in the solution of the present disclosure.

Two ways to construct the preset parameterized quantum circuit are given below, specifically including the followings.

### First Way

In this way, the preset parameterized quantum circuit includes L training layers, L is an even number greater than or equal to 2, and a value of L is related to the first error condition.

At least two of the L training layers include: a target revolving gate, where the rotation parameter x is used to perform a revolving operation on a first angle; a first revolving gate for performing a revolving operation on a second angle and acting on a qubit in the preset parameterized quantum circuit; and a second revolving gate for performing a revolving operation on a third angle and acting on a qubit in the preset parameterized quantum circuit; where a rotation angle ϕ of the first revolving gate and a rotation angle θ of the second revolving gate are the target adjustable parameters.

Here, the first target revolving gate and the second target revolving gate are target revolving gates in different training layers; that is, the target revolving gates in different training layers in the preset parameterized quantum circuit are replaced by different controlled unitary gates, for example, the target revolving gate (for ease of description, which may be called the first target revolving gate) in one training layer in the preset parameterized quantum circuit is replaced by the first controlled unitary gate, and at the same time, the target revolving gate (for ease of description, which may be called the second target revolving gate) in another training layer in the preset parameterized quantum circuit is replaced by the second controlled unitary gate, thus obtaining the target quantum circuit.

It should be noted that, in practical applications, the types and quantities of revolving gates contained in different other training layers among the L training layers may be the same (for example, they all include the revolving gates described above); or may be different, for example, some other training layers contain at least one of the revolving gates described above, and some other training layers also contain other quantum gates, etc., which are not limited in the solution of the present disclosure, as long as there are at least two training layers including the quantum gates described above.

In a specific example, the preset parameterized quantum circuit contains one qubit, and at this time, the target revolving gate, the first revolving gate and the second revolving gate are all single-qubit revolving gates acting on this qubit.

Further, in another example, the preset parameterized quantum circuit contains one qubit, and each of the L training layers contains a target revolving gate, a first revolving gate and a second revolving gate, that is, the target revolving gate, the first revolving gate and the second revolving gate of each training layer are all single-qubit revolving gates acting on this qubit.

### SecondWway

In this way, the preset parameterized quantum circuit includes L training layers, L is an even number greater than or equal to 2, and a value of L is related to the first error condition.

At least two of the L training layers include: a target revolving gate, where the rotation parameter x is used to perform a revolving operation on a first angle; and the first target revolving gate and second target revolving gate are target revolving gates in different training layers; and a second revolving gate for performing a revolving operation on a third angle and acting on a qubit in the preset parameterized quantum circuit; where a rotation angle θ of the second revolving gate is the target adjustable parameter.

That is to say, compared with the first way, the training layer among the at least two training layers does not contain the first revolving gate in the second way. It can be understood that, except for the first revolving gate, the relevant description of the first way is also applicable to the second way, and will not be repeated here.

Thus, the solution of the present disclosure effectively improves the expression ability of the preset parameterized quantum circuit, and at the same time, the types and quantities of quantum gates used are reduced, laying the foundation for efficiently estimating the degree of entanglement of the quantum state.

Further, in a specific example of the solution of the present disclosure, each angle satisfies one of the following conditions: the first angle is an angle corresponding to a z-axis, the second angle is an angle corresponding to the z-axis, or the third angle is an angle corresponding to a y-axis.

That is to say, in one example, the first angle is an angle corresponding to the z-axis; in another example, the second angle is an angle corresponding to the z-axis; in yet another example, the third angle is an angle corresponding to the y-axis; or, any two of the above conditions are satisfied, for example, the first angle and the second angle are both angles corresponding to the z-axis, etc. Alternatively, the above three conditions are satisfied at the same time, that is, the first angle and the second angle are both angles corresponding to the z-axis, and the third angle is an angle corresponding to the y-axis.

For example, in a specific example, at least two of the L training layers include: the target revolving gate, where the rotation parameter x is used to perform a revolving operation on the angle corresponding to the z-axis; the first revolving gate for performing a revolving operation on the angle corresponding to the z-axis; and the second revolving gate for performing a revolving operation on the angle corresponding to the y-axis.

Alternatively, in another example, at least two of the L training layers include: the target revolving gate, where the rotation parameter x is used to perform a revolving operation on the angle corresponding to the z-axis; and the second revolving gate for performing a revolving operation on the angle corresponding to the y-axis.

Further, in another specific example, the preset parameterized quantum circuit contains one qubit, and at this time, the target revolving gate, the first revolving gate and the second revolving gate are all single-qubit revolving gates acting on this qubit.

Further, each of the L training layers includes: the target revolving gate, where the rotation parameter x is used to perform a revolving operation on the angle corresponding to the z-axis; the first revolving gate for performing a revolving operation on the angle corresponding to the z-axis; and the second revolving gate for performing a revolving operation on the angle corresponding to the y-axis.

Alternatively, each of the L training layers includes: the target revolving gate, where the rotation parameter x is used to perform a revolving operation on the angle corresponding to the z-axis; and the second revolving gate for performing a revolving operation on the angle corresponding to the y-axis.

Thus, the solution of the present disclosure effectively improves the expression ability of the preset parameterized quantum circuit, and at the same time, the types and quantities of quantum gates used are reduced, and the quantity of target adjustable parameters to be trained is reduced, thus laying the foundation for efficiently estimating the degree of entanglement corresponding to the first quantum state.

Further, in another specific example of the solution of the present disclosure, when any of the L training layers contains the target revolving gate, the first revolving gate and the second revolving gate, the action order of revolving gates is: the first revolving gate, the second revolving gate, the target revolving gate.

Alternatively, in another specific example, when any of the L training layers contains the target revolving gate and the second revolving gate, the action order of revolving gates is: the second revolving gate, the target revolving gate.

That is to say, in a specific example, the target revolving gate, the first revolving gate and the second revolving gate included in each of at least two of the L training layers, according to the action order of revolving gates, sequentially include the first revolving gate for performing a revolving operation on the angle corresponding to the z-axis, the second revolving gate for performing a revolving operation on the angle corresponding to the y-axis, and the target revolving gate.

Alternatively, in another specific example, the target revolving gate and the second revolving gate included in each of at least two of the L training layers, according to the action order of revolving gates, sequentially include the second revolving gate for performing a revolving operation on the angle corresponding to the y-axis, and the target revolving gate.

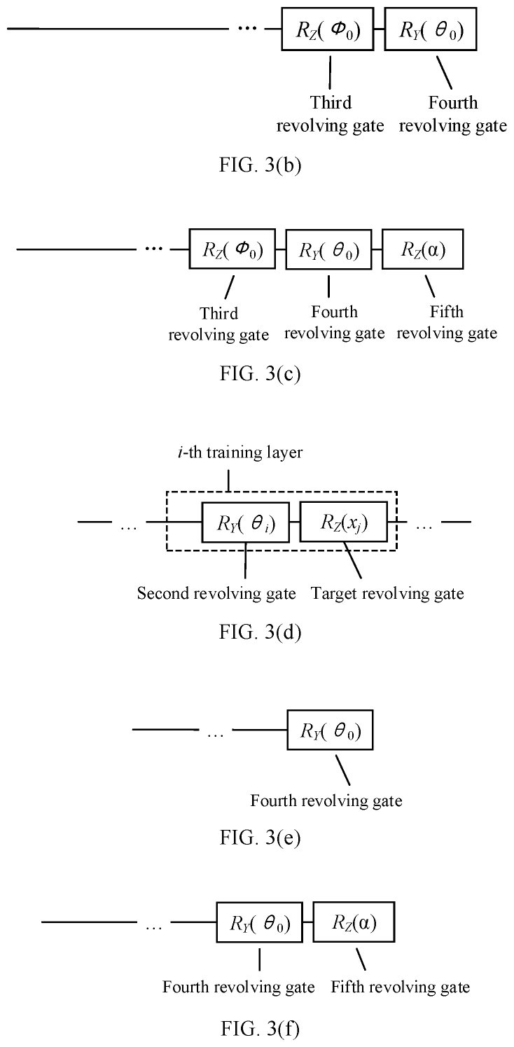

For example, the preset parameterized quantum circuit contains one qubit. Accordingly, the target revolving gate, the first revolving gate and the second revolving gate are all single-qubit revolving gates acting on this qubit. As shown in FIG. 3(a), one of at least two of the L training layers, e.g., the i-th training layer among the L training layers, according to the action order, sequentially includes a first revolving gate R_{Z}(ϕᵢ) with a rotation angle ϕᵢ being an angle corresponding to the z-axis, a second revolving gate R_{Y}(θᵢ) with a rotation angle θᵢ being an angle corresponding to the y-axis, and a target revolving gate R_{Z}(xⱼ) with a rotation parameter xⱼ being an angle corresponding to the z-axis.

Here, the rotation angle ϕᵢ of the first revolving gate R_{Z}(ϕᵢ) and the rotation angle θᵢ of the second revolving gate R_{Y}(θᵢ) are target adjustable parameters in the i-th training layer, where i is an integer greater than or equal to 1 and less than or equal to L. It should be understood that, in this example, the structure of another training layer among the at least two of the L training layers is also the structure as shown in FIG. 3(a), which will not be repeated here.

Further, in another specific example, the structure of each of the L training layers is the structure as shown in FIG. 3(a), which will not be repeated here.

For another example, the preset parameterized quantum circuit contains one qubit. Accordingly, the target revolving gate and the second revolving gate are both single-qubit revolving gates acting on this qubit. As shown in FIG. 3(d), one of at least two of the L training layers, e.g., the i-th training layer among the L training layers, according to the action order, sequentially includes a second revolving gate R_{Y}(θᵢ) with a rotation angle θᵢ being an angle corresponding to the y-axis, and a target revolving gate R_{Z}(x) with a rotation parameter xⱼ being an angle corresponding to the z-axis.

Here, the rotation angle θᵢ of the second revolving gate R_{Y}(θᵢ) is the target adjustable parameter in the i-th training layer, where i is an integer greater than or equal to 1 and less than or equal to L. It should be understood that, in this example, the structure of another training layer among the at least two of the L training layers is also the structure as shown in FIG. 3(d), which will not be repeated here.

Further, in another specific example, the structure of each of the L training layers is the structure as shown in FIG. 3(d), which will not be repeated here.

Thus, the solution of the present disclosure effectively improves the expression ability of the preset parameterized quantum circuit, and at the same time, the types and quantities of quantum gates used are reduced, and the quantity of target adjustable parameters to be trained is reduced, thus laying the foundation for efficiently estimating the degree of entanglement of the quantum state.

Further, in another specific example, other revolving gates are further included after the L training layers of the preset parameterized quantum circuit.

In a specific example, after the L training layers of the preset parameterized quantum circuit, it further includes a third revolving gate for performing a revolving operation on a fourth angle and acting on a qubit in the preset parameterized quantum circuit, and a fourth revolving gate for performing a revolving operation on a fifth angle and acting on the qubit in the preset parameterized quantum circuit; where a rotation angle ϕ₀ of the third revolving gate and a rotation angle θ₀ of the fourth revolving gate are the target adjustable parameters.

In a specific example, the preset parameterized quantum circuit contains one qubit, and at this time, the third revolving gate and the fourth revolving gate are both single-qubit revolving gates acting on this qubit.

For example, in an example, as shown in FIG. 3(b), after the L training layers, the preset parameterized quantum circuit further includes a third revolving gate R_{Z}(ϕ₀) with a rotation angle ϕ₀ being an angle corresponding to the z-axis, and a fourth revolving gate R_{Y}(θ₀) with a rotation angle θ₀ being an angle corresponding to the y-axis.

Here, the rotation angle ϕ₀ and the rotation angle θ₀ are also target adjustable parameters.

Based on this, the mathematical expression of the preset parameterized quantum circuit as shown in FIG. 3(b) may be specifically Uₓ_{ⱼ}(θ, ϕ)=R_{Y}(θ₀) R_{Z}(ϕ₀)Πᵢ₌₁^{L}R_{Z}(xⱼ)R_{Y}(θᵢ)R_{Z}(ϕᵢ).

In a specific example, after the L training layers, the preset parameterized quantum circuit further includes other revolving gates including a third revolving gate for performing a revolving operation on a fourth angle and acting on the qubit in the preset parameterized quantum circuit, a fourth revolving gate for performing a revolving operation on a fifth angle and acting on the qubit in the preset parameterized quantum circuit, and a fifth revolving gate for performing a revolving operation on a sixth angle and acting on the qubit in the preset parameterized quantum circuit; where the rotation angle ϕ₀ of the third revolving gate and the rotation angle θ₀ of the fourth revolving gate are the target adjustable parameters; and the rotation angle α of the fifth revolving gate is a fixed parameter, that is, a parameter that does not participate in training. Alternatively, the rotation angle ϕ₀ of the third revolving gate, the rotation angle θ₀ of the fourth revolving gate, and the rotation angle α of the fifth revolving gate are all the target adjustable parameters.

In a specific example, the preset parameterized quantum circuit contains one qubit, and at this time, the third revolving gate, the fourth revolving gate and the fifth revolving gate are all single-qubit revolving gates acting on this qubit.

For example, in another example, as shown in FIG. 3(c), after the L training layers, the preset parameterized quantum circuit further includes a third revolving gate R_{Z}(ϕ₀) with a rotation angle ϕ₀ being an angle corresponding to the z-axis, a fourth revolving gate R_{Y}(θ₀) with a rotation angle θ₀ being an angle corresponding to the y-axis, and a fifth revolving R_{Z}(α) with a rotation angle α being an angle corresponding to the z-axis.

Here, the rotation angles ϕ₀, θ₀ and a are all target adjustable parameters.

Based on this, the mathematical expression of the preset parameterized quantum circuit as shown in FIG. 3(c) may be specifically Uₓ_{ⱼ}(α, θ, ϕ)=R_{Z}(α)R_{Y}(θ₀)R_{Z}(ϕ₀)Πᵢ₌₁^{L}R_{Z}(xⱼ)R_{Y}(θᵢ)R_{Z}(ϕᵢ).

Alternatively, the rotation angle ϕ₀ and the rotation angle θ₀ are both target adjustable parameters, while the rotation angle α is a fixed parameter and does not participate in training.

Based on this, the mathematical expression of the preset parameterized quantum circuit as shown in be FIG. 3(c) may specifically: Uₓ_{ⱼ}(θ,ϕ)=R_{Z}(α) R_{Y}(θ₀) R_{Z}(ϕ₀)Πᵢ₌₁^{L}R_{Z}(xⱼ)R_{Y}(θᵢ)R_{Z}(ϕᵢ).

Alternatively, in another example, after the L training layers of the preset parameterized quantum circuit, it further includes a fourth revolving gate for performing a revolving operation on a fifth angle and acting on the qubit in the preset parameterized quantum circuit, where a rotation angle θ₀ of the fourth revolving gate is the target adjustable parameter.

It should be noted that, for the relevant content of the fourth revolving gate, reference may be made to the above description, which will not be repeated here. That is to say, compared with the structure shown in FIG. 3(b), in this example, as shown in FIG. 3(e), the fourth revolving gate is included and the third revolving gate is not included after the L training layers.

Alternatively, in yet another example, after the L training layers, the preset parameterized quantum circuit further includes other revolving gates including a fourth revolving gate for performing a revolving operation on a fifth angle and acting on the qubit in the preset parameterized quantum circuit, and a fifth revolving gate for performing a revolving operation on a sixth angle and acting on the qubit in the preset parameterized quantum circuit; where the rotation angle θ₀ of the fourth revolving gate is the target adjustable parameter; and the rotation angle α of the fifth revolving gate is a fixed parameter, that is, a parameter that does not participate in training. Alternatively, the rotation angle θ₀ of the fourth revolving gate, and the rotation angle α of the fifth revolving gate are all the target adjustable parameters.

It should be noted that, for the relevant content of the fourth revolving gate and the fifth revolving gate, reference may be made to the above description, which will not be repeated here. That is to say, compared with the structure shown in FIG. 3(c), in this example, as shown in FIG. 3(f), the fourth revolving gate and the fifth revolving gate are included and the third revolving gate is not included after the L training layers.

Thus, the solution of the present disclosure effectively improves the expression ability of the preset parameterized quantum circuit, and at the same time, the types and quantities of quantum gates used are reduced, and the quantity of target adjustable parameters to be trained is reduced, thus laying the foundation for efficiently estimating the degree of entanglement of the quantum state while laying the foundation for improving the accuracy of the result.

In a specific example of the solution of the present disclosure, the target quantum circuit contains M layers, and M is a positive integer greater than or equal to 1 and less than or equal to L/2.

At least one of the M layers is obtained by replacing a first target revolving gate of a first training layer among two training layers by the first controlled unitary gate, and replacing a second target revolving gate of a second training layer among the two training layers by the second controlled unitary gate, where the two training layers are any two of the L training layers.

It can be understood that this example is applicable to the first and second ways described above.

Here, the target quantum circuit is obtained by extending the preset parameterized quantum circuit, and is obtained by replacing two target revolving gates of different layers in the preset parameterized quantum circuit by the first controlled unitary gate and the second controlled unitary gate respectively, so the target quantum circuit contains at most L/2 layers.

Further, in the case where each training layer in the preset parameterized quantum circuit contains a target revolving gate, for example, each training layer contains the revolving gates in the first way, that is, the revolving gates as shown in FIG. 3(a), or each training layer contains the revolving gates in the second way, that is, the revolving gates as shown in FIG. 3(d), at this time, the target quantum circuit contains L/2 layers.

In a specific example, at least two (such as the i-th and (i+1)-th (or (i+2)-th, etc., which is only exemplary description, and other layers are possible) training layers) of the L training layers include the target revolving gate, the first revolving gate and the second revolving gate. At this time, the target quantum circuit has one layer, for example,

$$⌈ \frac{i}{2} ⌉ - th$$

layer ([*] is the symbol for rounding up to an integer), which is obtained after replacing the target revolving gate (that is, the first target revolving gate) of the (i+1)-th training layer (corresponding to the first training layer described above) by the first controlled unitary gate and replacing the target revolving gate (that is, the second target revolving gate) of the i-th training layer (i.e., the second training layer) by the second controlled unitary gate.

Further, at least one of the M layers is obtained based on two training layers in the preset parameterized quantum circuit, so at least one of the M layers in one example includes two first revolving gates, two second revolving gates, a first controlled unitary gate, and a second controlled unitary gate.

Further, in another example, according to the action order of the quantum gates, at least one of the M layers sequentially includes a first revolving gate, a second revolving gate, a first controlled unitary gate, a first revolving gate, a second revolving gate, and a second controlled unitary gate.

Alternatively, in another example, at least one of the M layers includes two second revolving gates, a first controlled unitary gate, and a second controlled unitary gate.

Further, in another example, according to the action order of the quantum gates, at least one of the M layers sequentially includes a second revolving gate, a first controlled unitary gate, a second revolving gate, and a second controlled unitary gate.

Here, the relevant introduction of the quantum gates in this example can refer to the above description, and will not be repeated here.

Thus, in the process of constructing the target quantum circuit on the basis of the preset parameterized quantum circuit, the solution of the present disclosure effectively improves the expressive ability of the target quantum circuit, and at the same time, the types and quantities of quantum gates used are reduced, and the quantity of target adjustable parameters to be trained is also reduced, thus laying the foundation for efficiently estimating the degree of entanglement of the quantum state while laying the foundation for improving the accuracy of the result.

Moreover, in the process of constructing the target quantum circuit based on the preset parameterized quantum circuit, different construction methods may be used, so the solution of the present disclosure has strong scalability.

In a specific example of the solution of the present disclosure, the two training layers are any adjacent two of the L training layers. That is to say, at least one of the M layers is obtained based on two adjacent training layers in the preset parameterized quantum circuit.

In a specific example, each of any two adjacent training layers (such as the i-th and (i+1)-th training layers) among the L training layers includes the target revolving gate, the first revolving gate and the second revolving gate. At this time, the target quantum circuit has one layer, for example,

$$⌈ \frac{i}{2} ⌉ - th$$

layer, which is obtained after replacing the target revolving gate (that is, the first target revolving gate) of the (i+1)-th training layer (that is, the first training layer) by the first controlled unitary gate and replacing the target revolving gate (that is, the second target revolving gate) of the i-th training layer (the second training layer) by the second controlled unitary gate.

Further, in one example, each layer in the target quantum circuit is obtained based on two adjacent training layers in the preset parameterized quantum circuit, for example, each layer is obtained after replacing a first target revolving gate of a first training layer in two adjacent training layers of the preset parameterized quantum circuit by a first controlled unitary gate and replacing a second target revolving gate of a second training layer in the two training layers by a second controlled unitary gate. At this time, the quantity of first controlled unitary gates and the quantity of second controlled unitary gates in the target quantum circuit are both half of the quantity of target revolving gates in the preset parameterized quantum circuit.

Specifically, when each training layer in the preset parameterized quantum circuit includes the target revolving gate, the first revolving gate and the second revolving gate, and the action order of the revolving gates is as shown in FIG. 3(a),

$$⌈ \frac{i}{2} ⌉ - th$$

layer among the L/2 layers of the target quantum circuit is obtained by replacing the target revolving gate (that is, the first target revolving gate) of the (i+1)-th training layer by the first controlled unitary gate, and replacing the target revolving gate (that is, the second target revolving gate) of the i-th training layer by the second controlled unitary gate.

Specifically, as shown in FIG. 4(a), the

$$⌈ \frac{i}{2} ⌉ - th$$

layer (the value of i is 1 to L) in the target quantum circuit, according to the action order of the quantum gates, includes a first revolving gate R_{Z}(ϕᵢ₊₁) with a rotation angle ϕᵢ₊₁ being an angle corresponding to the z-axis, a second revolving gate R_{Y}(θᵢ₊₁) with a rotation angle θᵢ₊₁ being an angle corresponding to the y-axis, a first controlled unitary gate, a first revolving gate R_{Z}(ϕᵢ) with a rotation angle ϕᵢ being an angle corresponding to the z-axis, a second revolving gate R_{Y}(θᵢ) with a rotation angle θᵢ being an angle corresponding to the y-axis, and a second controlled unitary gate.

Alternatively, when each training layer in the preset parameterized quantum circuit includes the target revolving gate and the second revolving gate, and the action order of the revolving gates is as shown in FIG. 3(d), the

$$⌈ \frac{i}{2} ⌉ - th$$

layer among the L/2 layers of the target quantum circuit is obtained by replacing the target revolving gate (that is, the first target revolving gate) of the (i+1)-th training layer by the first controlled unitary gate, and replacing the target revolving gate (that is, the second target revolving gate) of the i-th training layer by the second controlled unitary gate.

$$⌈ \frac{i}{2} ⌉ - th$$

Specifically, as shown in FIG. 4(b), the layer (the value of i is 1 to L) in the target quantum circuit, according to the action order of the quantum gates, includes a second revolving gate R_{Y}(θᵢ₊₁) with a rotation angle θᵢ₊₁ being an angle corresponding to the y-axis, a first controlled unitary gate, a second revolving gate R_{Y}(θᵢ) with a rotation angle θᵢ being an angle corresponding to the y-axis, and a second controlled unitary gate.

It should be noted that different layers in the target quantum circuit act on the same auxiliary register; and the different layers also act on the same main register. That is to say, in practical applications, the qubit in the preset parameterized quantum circuit may be used as the auxiliary register at first; and after the main register is expanded from the preset parameterized quantum circuit, the target revolving gate in each training layer in the preset parameterized quantum circuit is replaced by a target controlled unitary gate, so that all the layers share the same auxiliary and main registers.

In this way, the solution of the present disclosure constructs the target quantum circuit based on the preset parameterized quantum circuit, and this process has low consumption. Also, the unitary operator can be controlled by through auxiliary register, the state information of the auxiliary register is measured, and the k-order trace corresponding to the first quantum state is obtained, and then the degree of entanglement corresponding to the first quantum state is estimated. Compared with the existing scheme, the solution of the present disclosure effectively reduces the required quantum computing resources, and enhances the feasibility of the medium-scale quantum computing device to solve the quantum feature.

It should be noted that, in the solution of the present disclosure, as shown in FIG. 4(a) or 4(b), when the quantum state of the auxiliary register is |0 [symbol] , the controlled unitary gate U^{†} (that is, the second controlled unitary gate) with a hollow core in the target quantum circuit is activated. When the quantum state of the auxiliary register is |1 [symbol] , the controlled unitary gate U (that is, the first controlled unitary gate) with a solid core is activated. That is to say, in practical applications, when the current quantum state of the auxiliary register is determined, the first controlled unitary gate works or the second controlled unitary gate works, instead of both. In this way, the solution of the present disclosure can control the unitary operator through the auxiliary register, measure the state information of the auxiliary register, and then estimate the degree of entanglement corresponding to the first quantum state. Compared with the existing scheme, the solution of the present disclosure effectively reduces the required quantum computing resources, and enhances the feasibility of the medium-scale quantum computing device to solve the quantum feature. Moreover, the solution of the present disclosure is applicable to any quantum state and has abundant application scenarios.

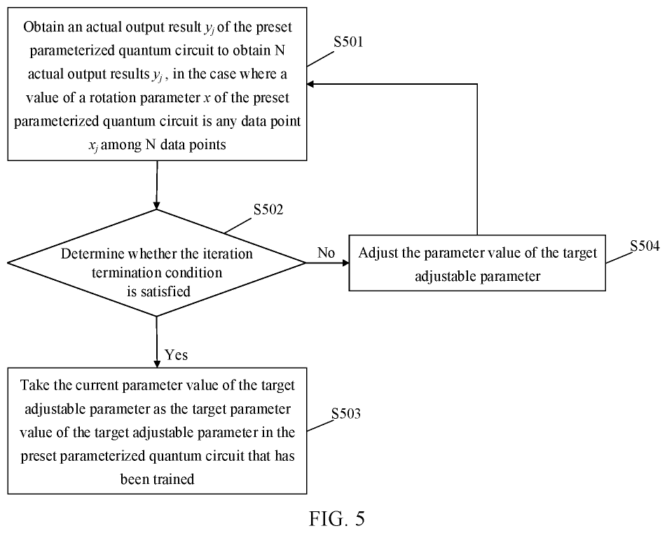

In a specific example of the solution of the present disclosure, the target parameter value of the target adjustable parameter in the sub-circuit is obtained in the following training way, that is, the preset parameterized quantum circuit (as constructed in the first or second way) is trained in the following way, and the target parameter value of the target adjustable parameter is obtained by training; and specifically, as shown in FIG. 5, the method further includes the followings.

In step S501, obtain an actual output result yⱼ of the preset parameterized quantum circuit to obtain N actual output results yⱼ, in the case where a value of a rotation parameter x of the preset parameterized quantum circuit is any data point xⱼ among N data points; and execute step S502. That is to say, when j takes a value from 1 to N, N actual output results yⱼ may be obtained.

Here, the actual output result yⱼ is an output result of the preset parameterized quantum circuit with the target adjustable parameter in the preset parameterized quantum circuit at a current parameter value; and N is a positive integer greater than or equal to 1, j=1, 2, . . . , N, and the rotation parameter x includes the first rotation parameter and the second rotation parameter.

It can be understood that, in the structure shown in FIG. 4(a), the rotation parameters corresponding to the target revolving gates in different layers may be collectively referred to as rotation parameter.

In step S502, determine whether the iteration termination condition is satisfied; if so, execute step S503; otherwise, execute step S504.

Here, the iteration termination condition includes at least one of 1) determining that a loss value of a preset loss function satisfies a convergence condition based on the N actual output results yⱼ and N target output results ŷⱼ, where the target output result is ŷⱼ=ƒ(xⱼ), and 2) the current quantity of iterations reaches a preset number.

In practical applications, as long as one of the above conditions is satisfied, the iteration termination condition can be satisfied.

In step S503, take the current parameter value of the target adjustable parameter as the target parameter value of the target adjustable parameter in the preset parameterized quantum circuit that has been trained.

In step S504, adjust the parameter value of the target adjustable parameter, and return to step S501.

In this way, the target parameter value of the target adjustable parameter of the sub-circuit is obtained by training other parameterized quantum circuits. Here, since the preset parameterized quantum circuit has a simpler circuit structure than the target quantum circuit, the way to obtain the target parameter value of the target adjustable parameter by training the preset parameterized quantum circuit can effectively reduce the amount of calculation and lay the foundation for efficiently determining the degree of entanglement corresponding to the first quantum state.

In a specific example of the solution of the present disclosure, the unitary operator may be specifically in two forms as follows.

Form 1: unitary operator U:=e^{iρ}, specifically, when the unitary operator U is obtained based on the first quantum system, an equivalent circuit of the first controlled unitary gate in the target quantum circuit is an equivalent circuit of the unitary operator U:=e^{iρ}, and an equivalent circuit of the second controlled unitary gate in the target quantum circuit is an equivalent circuit of the conjugate transpose U^{†}:=e^{-iρ} of the unitary operator U, where p represents the first quantum state.

In Form 1, the objective function

$$f ( x ) = \frac{{x}^{k}}{2 {π}^{k}} ,$$

where k is the above-mentioned order. Here, it should be noted that the selection of the objective function ƒ(x) is not unique; and in practical applications, the above objective function

$$\frac{{x}^{k}}{2 {π}^{k}}$$

may also be transformed, as long as it can be normalized, that is, the value of ƒ(x) is in [−1, 1] when the value of x is in [−π, π].

That is to say, in a specific example, the unitary operator U is obtained based on the first quantum system, for example, the unitary operator U:=e^{iρ}, and the conjugate transpose U^{†} of the unitary operator U is equal to e^{-iρ}. At this time, as shown in FIG. 4(a) or 4(b), the quantity of qubits contained in the main register in the target quantum circuit is equal to the quantity of qubits contained in the first quantum system, for example, equal to n; and at this time, the first controlled unitary gate (for convenience of description, the first controlled unitary gate may also be represented by U) is the equivalent circuit of the unitary operator U:=e^{iρ}, and the second controlled unitary gate (which may also be represented by U^{†}) is the equivalent circuit of U^{†}:=e^{-iρ}.

It should be noted that, in Form 1, the first input state of the auxiliary register of the target quantum circuit is the preset initial state, and the second input state of the main register is the first quantum state.

Form 2: unitary operator U:=RE, specifically, when the unitary operator U is obtained

based on the total quantum system corresponding to the first quantum system, an equivalent circuit of the first controlled unitary gate in the target quantum circuit is an equivalent circuit of the unitary operator U:=RE, and an equivalent circuit of the second controlled unitary gate in the target quantum circuit is an equivalent circuit of the conjugate transpose U^{†}:=(RE)^{†} of the unitary operator U; where E represents block encoding of the first quantum state; and R represents a reflection operator (Reflector) constructed based on the total quantum system.

In Form 2, the objective function

$$f ( x ) = {( {cos}^{2} x )}^{\frac{k}{2}} ,$$

where k is the above-mentioned order. It should be noted that the selection of the objective function ƒ(x) is not unique; and in practical applications, the above objective function

$${( {cos}^{2} x )}^{\frac{k}{2}}$$

may also be transformed, as long as it can be normalized, that is, the value of ƒ(x) is in [−1, 1] when the value of x is in [−π, π].

That is to say, in another specific example, the unitary operator U is obtained based on the total quantum system corresponding to the first quantum system. For example, for the scene where the total quantum system is formed by the first quantum system A and the second quantum system B and the bipartite quantum state of the total quantum system is |ψ [symbol] , the unitary operator U:=RE, and the conjugate transpose U^{†} of the unitary operator U is equal to (RE)^{†}. At this time, the objective function may also be specifically

$${( {cos}^{2} x )}^{\frac{k}{2}} ,$$

that is, the objective function

$$f ( x ) = {( {cos}^{2} x )}^{\frac{k}{2}} .$$

Accordingly, the first controlled unitary gate is an equivalent circuit of the unitary operator U:=RE, and the second controlled unitary gate is an equivalent circuit of (RE)^{†}.

Further, in this example, the quantity of qubits contained in the main register in the target quantum circuit=the quantity of qubits contained in the first quantum system A (for example, n)+the quantity of qubits contained in the total quantum system (for example, n+n′), where n′ is the quantity of qubits contained in the second quantum system B in the total quantum system, that is, the quantity of qubits corresponding to the second quantum state. Based on this, in a specific example, the quantity of main qubits contained in the main register is 2n+n′.

Here, E is block encoding of the first quantum state, and the expression form thereof is:

$$E = ( \begin{matrix}ρ & … \\ … & …\end{matrix} ) .$$

That is, the block encoding E is a unitary operator in which the upper left corner is the density matrix ρ of the first quantum state of the first quantum system A.

Further, an operator, that may be referred to as V operator (that is, the target state generation operator, and the target state is the bipartite quantum state |ψ [symbol] in this example), used to generate the bipartite quantum state |ψ [symbol] is constructed, and the V operator satisfies V|0^{n+n′} [symbol] |ψ [symbol] . As shown in FIG. 4(d), the equivalent circuit of the block encoding E (according to the action order of quantum gates) includes an V operator acting on a first group of qubits and a second group of qubits, a Swap gate acting on the second group of qubits and a third group of qubits, and a conjugate transpose V^{†} of the V operator acting on the first group of qubits and the second group of qubits.

Here, the quantity of qubits contained in the first group of qubits is related to the quantity of qubits corresponding to the second quantum state (that is, contained in the second quantum system), for example, equal to the quantity n′ of qubits contained in the second quantum system B; the quantity of qubits contained in the second group of qubits is related to the quantity of qubits corresponding to the first quantum state (that is, contained in the first quantum system A), for example, equal to the quantity n of qubits corresponding to the first quantum state; and the quantity of qubits contained in the third group of qubits is related to the quantity of qubits corresponding to the first quantum state (that is, contained in the first quantum system A), for example, also equal to the quantity n of qubits corresponding to the first quantum state.

It should be noted that the first group of qubits, the second group of qubits and the third group of qubits may be collectively referred to as a main register in this example.

Further, a Reflector R in the following form is constructed: R=2|0^{n+n′} [symbol] 0^{n+n′}|−I. Here, I is a unit matrix.

Further, an equivalent circuit of the first controlled unitary gate U:=RE and an equivalent circuit of the second controlled unitary gate U^{†}:=(RE)^{†} may be constructed based on the block encoding E and the Reflector R.

Specifically, as shown in FIG. 4(e), the equivalent circuit of the first controlled unitary gate U:=RE in the

$$⌈ \frac{i}{2} ⌉ - th$$

layer in the target quantum circuit, according to the action order of quantum gates, includes an V operator acting on a first group of qubits and a second group of qubits, a Swap gate controlled by the auxiliary register and acting on the second group of qubits and a third group of qubits, a conjugate transpose V^{†} of the V operator acting on the first group of qubits and the second group of qubits, and a Reflector R controlled by the auxiliary register and acting on the first group of qubits and the second group of qubits.

And, the equivalent circuit of the second controlled unitary gate U^{†}:=(RE)^{†} in the

$$⌈ \frac{i}{2} ⌉ - th$$

layer in the target quantum circuit, according to the action order of quantum gates, includes a Reflector R controlled by the auxiliary register and acting on a first group of qubits and a second group of qubits, an V operator acting on the first group of qubits and the second group of qubits, a Swap gate controlled by the auxiliary register and acting on the second group of qubits and a third group of qubits, and a conjugate transpose V^{†} of the V operator acting on the first group of qubits and the second group of qubits.

It can be understood that, similar to FIG. 4(b), in this example, as shown in FIG. 4(f), all the first revolving gates R_{Z}(ϕᵢ) in FIG. 4(e) may also be deleted; and further, when the target quantum circuit contains a third revolving gate R_{Z}(ϕ₀), the third revolving gate R_{Z}(ϕ₀) may also be deleted, to obtain the target quantum circuit based on the expansion of FIG. 3(d) and FIG. 3(e) or obtain the target quantum circuit based on the expansion of FIG. 3(d) and FIG. 3(f), to simulate an even function, further reducing the circuit depth by half while achieving the same effect.

It should be noted that, in the solution of the present disclosure, as shown in FIG. 4(e) or FIG. 4(f), when the quantum state of the auxiliary register is |0 [symbol] , the Reflector R with hollow core and the Swap gate with hollow core in the second controlled unitary gate of the target quantum circuit are activated. When the quantum state of the auxiliary register is |1 [symbol] , the Reflector R with solid core and the Swap gate with solid core in the first controlled unitary gate of the target quantum circuit are activated. That is to say, in practical applications, when the current quantum state of the auxiliary register is determined, the Reflector R and the Swap gate in the first controlled unitary gate work, or the Reflector R and the Swap gate in the second controlled unitary gate work.

Thus, the present disclosure provides a specific expression form of the unitary operator, which is convenient to realize through the equivalent circuit, and greatly improves the practicability on the medium-scale quantum device with noise and has strong scalability.

Based on this, the solution of the present disclosure has the following advantages.
1. The width of the target quantum circuit required in the solution of the present disclosure is smaller. Compared with the quantity of auxiliary qubits required in the existing scheme, the quantity of auxiliary qubits in the target quantum circuit in the solution of the present disclosure may be 1. Therefore, compared with the existing scheme, the target quantum circuit used in the solution of the present disclosure has the smallest width, thereby laying the foundation for effectively reducing the amount of calculation and improving the processing efficiency, and at the same time, the precision is high.
2. The solution of the present disclosure is easier to implement. In terms of the complexity and quantity of quantum gates, compared with the existing scheme, the quantities and types of quantum gates used in the target quantum circuit in the solution of the present disclosure are less; for example, a controlled unitary gate (such as the first controlled unitary gate and the second controlled unitary gate) controlled by a single qubit may be used, thus reducing the required quantum computing resources, and also increasing the feasibility of execution in the medium-scale quantum computing device.
3. The practicability is stronger. The target quantum circuit constructed by the solution of the present disclosure is simple, less expensive and more practical.

The solution of the present disclosure will be further described in detail in conjunction with specific examples below; and specifically, the degree of entanglement of the bipartite quantum state |ψ [symbol] on a total quantum system (formed by the first quantum system (denoted as A) and the second quantum system (denoted as B)) may be completely characterized by the feature value of the reduced density matrix.

For example, the degree of entanglement of the bipartite quantum state |ψ [symbol] may be completely characterized by the feature value of the first quantum state (for the convenience of distinction, the first quantum state may also be denoted as ρ_{A}). Here, ρ_{A}=Tr_{B}(|ψ [symbol] ψ|), representing the partial trace of the bipartite quantum state |ψ [symbol] on the first quantum system A.

Here, the feature value of the first quantum state ρ_{A} (denoted as {λⱼ}ⱼ₌₁^{D}) is called the entanglement spectroscopy of the bipartite quantum state |ψ [symbol] , and D=2ⁿ is the dimension of the first quantum state ρ_{A}.

Further, according to the Newton-Girard method, the feature value of the first quantum state ρ_{A} may be calculated by the following equation: (x−λ₁)(x−λ₁) . . . (x−λ_{N})=Σₖ₌₀^{N}(−1)^{N-k}e_{N-k}x^{k}, where e₀=1, e₁=R₁, e₂=½(e₁R₁−R₂), e₃=⅓(e₂R₁−e₁R₂+R₃), e₄=¼(e₃R₁−e₂R₂+e₁R₃−R₄), . . . , and

$${e}_{N} = \frac{1}{N} {\sum }_{k = 1}^{N} {( - 1 )}^{k - 1} {e}_{N - k} {R}_{k} .$$

Here, Rₖ=Tr(ρ_{A}^{k}) represents the k-order trace of the first quantum state ρ_{A}. In practical applications, when the dimension D is very large, it is difficult to calculate the complete entanglement spectroscopy, so it is necessary to roughly estimate the entanglement spectroscopy. For example, set the preset maximum order kₘₐₓ (a positive integer kₘₐₓ<D), and at this time, the first kₘₐₓ maximum feature values of the first quantum state ρ_{A} may be estimated by calculating the first kₘₐₓ order traces, namely R₁, R₂, . . . , Rₖ_{ₘₐₓ}.

Based on this, the estimation issue of the entanglement spectroscopy may be summarized as follows.

Input: a reduced quantum state (that is, the first quantum state) ρ_{A} of dimension N=2ⁿ on the first quantum system A. Here, the input first quantum state ρ_{A} may be obtained directly based on the first quantum system, or may be estimated based on the partial trace of the bipartite quantum state |ψ [symbol] .

Output: estimated values of the first kₘₐₓ maximum feature values of the first quantum state ρ_{A}, namely {\hat{λ}ⱼ}ⱼ₌₁^{k}^{ₘₐₓ}. Further, the estimated feature values of the first quantum state ρ_{A} are used to estimate the degree of entanglement of the bipartite quantum state |ψ [symbol] .

Specifically, the purpose of the solution of the present disclosure is to provide a practical and efficient solution for estimating the quantum entanglement spectroscopy, which is mainly divided into three parts: Part I is to simulate an objective function, such as

$$f ( x ) = \frac{{x}^{k}}{2 {π}^{k}}$$

(k represents the order and is a positive integer), based on quantum signal processing or quantum neural network, and in this part a preset parameterized quantum circuit may be constructed and trained, to enable the preset parameterized quantum circuit to simulate the objective function ƒ(x); Part II is to use the target parameter value obtained in the Part I to realize the calculation of the k-order trace of any quantum state; and finally, Part III is to use the 2 to kₘₐₓ order traces estimated in the Part II to complete the estimation of the entanglement spectroscopy.

Here, the solution of the present disclosure utilizes the ability of the quantum revolving gate sequence to simulate any square-integrable function (that is, ƒ(x)) combined with the extraction ability of the trigonometric polynomial, and efficiently solves the issue of entanglement spectroscopy estimation by obtaining the expected value through quantum measurement.

Part I (i.e., Program 1) is mainly used to calculate or optimize the target adjustable parameter of the revolving gate on the auxiliary register; and this Program 1 is a subprogram that will be called by Program 2.

In step 11, input the order k and an error tolerance value ϵ>0.

Here, the error tolerance value ϵ can constrain the degree of difference between the actual output result output by the preset parameterized quantum circuit for simulating the objective function ƒ(x) and the target output result.

In step 12, construct a preset parameterized quantum circuit to be trained, and determine the quantity of training layers of the preset parameterized quantum circuit to be trained, for example, including L training layers, according to the error tolerance value ϵ; and further, determine the quantity N of training data sets based on the error tolerance value ϵ. Here, L is an even number greater than or equal to 2, and N is also a positive integer greater than or equal to 1.

Here, in this example, the preset parameterized quantum circuit is a parameterized circuit including one qubit (which may be called an auxiliary qubit or auxiliary register in this example).

It should be noted that, in practical applications, a preset parameterized quantum circuit containing two or more qubits may also be constructed to simulate the objective function ƒ(x), which is not limited in the solution of the present disclosure. The preset parameterized quantum circuit is within the scope of protection of the solution of the present disclosure, as long as it is able to be used to simulate the objective function and extended to obtain a target parameter subcircuit capable of solving the feature phase.

In this example, each of the L training layers of the preset parameterized quantum circuit includes a quantum revolving gate sequence, and the quantum revolving gate sequence in each training layer is the same.

It should be noted that, in practical applications, the quantum revolving gate sequences contained in different training layers among the L training layers may be the same or different; or the quantum revolving gate sequences contained in some training layers are the same, and the quantum revolving gate sequences contained in other some training layers are different, etc., which is not specifically limited in the solution of the present disclosure.

Further, in this example, the quantum revolving gate sequence contained in the i-th training layer among the L training layers is taken as an example for illustration. As shown in FIG. 3(a), based on the action order of the revolving gates in the quantum revolving gate sequence, the quantum revolving gate sequence contained in the i-th training layer sequentially includes a first revolving gate R_{Z}(ϕᵢ) with a rotation angle ϕᵢ being an angle corresponding to the z-axis, a second revolving gate R_{Y}(θᵢ) with a rotation angle θᵢ being an angle corresponding to the y-axis, and a target revolving gate R_{Z}(xⱼ) with a rotation parameter x being an angle corresponding to the z-axis.

Here, the rotation angle ϕᵢ of the first revolving gate R_{Z}(ϕᵢ) and the rotation angle θᵢ of the second revolving gate R_{Y}(θᵢ) are target adjustable parameters in the i-th training layer, where i is an integer greater than or equal to 1 and less than or equal to L.

Further, in this example, after the L training layers, the preset parameterized quantum circuit further includes other revolving gates.

Specifically, in an example, as shown in FIG. 3(b), after the L training layers, the preset parameterized quantum circuit further includes a third revolving gate R_{Z}(ϕ₀) with a rotation angle ϕ₀ being an angle corresponding to the z-axis, and a fourth revolving gate R_{Y}(θ₀) with a rotation angle θ₀ being an angle corresponding to the y-axis.

Based on this, the mathematical expression of the preset parameterized quantum circuit as shown in FIG. 3(b) may be specifically Uₓ_{ⱼ}(θ,ϕ)=R_{Y}(θ₀) R_{Z}(ϕ₀) Πᵢ₌₁^{L}R_{Z}(xⱼ)R_{Y}(θᵢ)R_{Z}(ϕᵢ).

Alternatively, in another example, as shown in FIG. 3(c), after the L training layers, the preset parameterized quantum circuit further includes a third revolving gate R_{Z}(ϕ₀) with a rotation angle ϕ₀ being an angle corresponding to the z-axis, a fourth revolving gate R_{Y}(θ₀) with a rotation angle θ₀ being an angle corresponding to the y-axis, and a fifth revolving R_{Z}(α) with a rotation angle α being an angle corresponding to the z-axis.

Here, the rotation angles ϕ₀, θ₀ and a are all target adjustable parameters.

Based on this, the mathematical expression of the preset parameterized quantum circuit as shown in FIG. 3(c) may be specifically Uₓ_{ⱼ}(α, θ, ϕ)=R_{Z}(α) R_{Y}(θ₀) R_{Z}(ϕ₀) Πᵢ₌₁^{L}R_{Z}(xⱼ)R_{Y}(θᵢ)R_{Z}(ϕᵢ).

Alternatively, the rotation angle ϕ₀ and the rotation angle θ₀ are both target adjustable parameters, while the rotation angle α is a fixed parameter and does not participate in training.

Based on this, the mathematical expression of the preset parameterized quantum circuit as shown in FIG. 3(c) may be specifically Uₓ_{ⱼ}(θ, ϕ)=R_{Z}(α) R_{Y}(θ₀) R_{Z}(ϕ₀) Πᵢ₌₁^{L}R_{Z}(xⱼ)R_{Y}(θᵢ) R_{Z}(ϕᵢ).

It should be noted that the circuit structure of each of the L training layers may refer to the structure shown in FIG. 3(a), and is not shown in FIG. 3(b) and FIG. 3(c).

It should be noted that the preset parameterized quantum circuit includes one qubit, so the classical computing device may be used to effectively and precisely simulate the operation and expected value of the preset parameterized quantum circuit, that is, without consuming the quantum computing resources, thus saving the quantum computing resources and also reducing the processing cost.

Further, it can be understood that, in practical applications, when the quantity of qubits contained in the preset parameterized quantum circuit is less (for example, 20 to 30 qubits), the target parameter value of the target adjustable parameter may be calculated in the classical computing device by means of analog circuit, so that the consumption of quantum computing resources is avoided to the greatest extent within the allowable range of computing efficiency.

In step 13, prepare a training data set; for example, prepare N training data points {xⱼ}ⱼ₌₁^{N} for training the above-mentioned preset parameterized quantum circuit.

This example is illustrated by taking the preset parameterized quantum circuit shown in FIG. 3(c) as an example, and the rotation angle α is a target adjustable parameter and participates in the subsequent training process. Accordingly, the target quantum circuit obtained by extending based on the preset parameterized quantum circuit shown in FIG. 3(c) is as shown in FIG. 4(c).

In step 14, randomly generate L+1 parameter values θ, L+1 parameter values ϕ, and one parameter value α.

Here, L+1 parameter values θ may be recorded as θ₀ and {θᵢ}ᵢ₌₁^{L} respectively (i is a positive integer greater than or equal to 1 and less than or equal to L). For the convenience of recording, it may also be represented by a vector θ∈ [symbol] ^{L+1}, that is, θ={θ₀, θ₁, . . . , θᵢ, . . . , θ_{L}}.

Similarly, L+1 parameter values ϕ∈ [symbol] ^{L+1} may be recorded as ϕ₀ and {ϕᵢ}ᵢ₌₁^{L} respectively (i is a positive integer greater than or equal to 1 and less than or equal to L). For the convenience of recording, it may also be represented by a vector ϕ, that is, ϕ=ϕ={ϕ₀, ϕ₁, . . . , ϕᵢ, . . . , ϕ_{L}}.

At this time, the preset parameterized quantum circuit may be expressed as Uₓ(α, θ, ϕ).

In step 15, for each rotation parameter xⱼ (1≤j≤N), perform the following operations.
(a) Use a classical simulator (that is, on a classical computing device) to simulate the above-mentioned preset parameterized quantum circuit Uₓ(α, θ, ϕ) containing a single qubit; and specifically obtain the preset parameterized quantum circuit Uₓ_{ⱼ}(α, θ, ϕ) for each xⱼ.
(b) Input the preset initial state, such as |0 [symbol] , and use the classical simulator to simulate and obtain the expected value of an observable quantity Z, that is, obtain the actual output result of the auxiliary register, denoted as yⱼ.

After the above operations are performed for each xⱼ, that is, after the above operations are completed, a set of actual output results {yⱼ}ⱼ₌₁^{N} (N results in total) are obtained.

In step 16, take the 2-norm between the actual output result {Yⱼ}ⱼ₌₁^{N} and the target output result

$${\{ {\hat{y}}_{j} := \frac{{x}_{j}^{k}}{2 {π}^{k}} \}}_{j = 1}^{N}$$

as the loss function, that is, the loss function L(α, θ, ϕ) is L(α, θ, ϕ):=\sqrt{Σⱼ₌₁^{N}(yⱼ−ŷⱼ)²}.

Here, it can be understood that, in practical applications, the loss function may also be any other measurement function describing the distance, such as the mean absolute error function, mean square error function and cross entropy function, etc. An appropriate loss function may be selected according to factors such as data size, hardware environment, learning precision or convergence speed, which is not specifically limited in the solution of the present disclosure.

In step 17, calculate a loss value based on the loss function L(α, θ, ϕ), and optimize the loss value, for example, adjust the target adjustable parameters α, θ and ϕ by the gradient descent method to minimize L(α, θ, ϕ), where the target adjustable parameter θ includes θ₀ and {θᵢ}ᵢ₌₁^{L}, that is, θ={θ₀, θ₁, . . . , θᵢ, . . . , θ_{L}}; and the target adjustable parameter ϕ includes ϕ₀ and {ϕᵢ}ᵢ₌₁^{L}, that is, ϕ={ϕ₀, ϕ₁, . . . , ϕᵢ, . . . , ϕ_{L}}.

Here, in practical applications, the common gradient descent method or other more scientific and effective optimization methods may be used on the classical computing device to optimize the target adjustable parameters α, θ₀, {θᵢ}ᵢ₌₁, ϕ₀ and {ϕᵢ}=1^{L}, thus minimizing the loss value of the loss function. The solution of the present disclosure does not limit the specific optimization method.

In step 18, repeat steps 15 to 17 after adjusting the target adjustable parameters, until the loss function L(α, θ, ϕ) converges or the quantity of iterations is reached to obtain the optimal parameter value (that is, target parameter values) of each target adjustable parameter, respectively \hat{α}, \hat{θ} and \hat{ϕ}.

Here, \hat{θ}={\hat{θ}₀, \hat{θ}₁, . . . , \hat{θ}ᵢ, . . . , \hat{θ}_{L}} and \hat{ϕ}={\hat{ϕ}₀, \hat{ϕ}₁, . . . , \hat{ϕ}ᵢ, . . . , \hat{ϕ}_{L}}.

It can be understood that the above optimization process is repeated to minimize the loss value of the loss function or reach the convergence state or reach the quantity of iterations. At this time, the actual output result yⱼ may be considered to be close to the target output result ŷⱼ, and the current parameter values \hat{α}, \hat{θ} and \hat{ϕ} of the target adjustable parameters are the optimal parameter values.

In step 19, output the optimal parameter values (that is, target parameter values) \hat{α}, \hat{θ} and \hat{ϕ} (2L+3 in total).

It can be understood that, in practical applications, Program 1 may be operated in a classical computing device or in a quantum computing device without considering the calculation cost, which is not specifically limited in the solution of the present disclosure.

In practical applications, the implementation of the above Program 1 is not unique. For example, in the process of initializing the target adjustable parameters (such as the above step 14), the inherent properties of these target adjustable parameters may be used, or the initial values thereof may be set, to improve the optimization efficiency; or, the method of function analysis may also be used to directly obtain the optimal parameter values of the target adjustable parameters. In other words, in practical applications, an appropriate implementation manner may be selected based on factors such as specific application scenario and hardware environment.

As an example, the function analysis method is used to calculate the target adjustable parameters, specifically including the followings.

An objective function ƒ(x) is input, which can be abbreviated as ƒ. The objective Fourier series F(x) which can approximate the objective function ƒ within the objective definition domain is calculated. And, other Fourier series P(x) and Q(x) are calculated; where

$$P ( x ) = \sqrt{\frac{1 + F ( x )}{2}} ; Q ( x ) = \sqrt{\frac{1 - F ( x )}{2}} .$$

The optimal parameter values of the target adjustable parameters α, θ and ϕ are recursively calculated according to the following equation:

$$[ \begin{matrix}P ( x ) & - Q ( x ) \\ {Q}^{*} ( x ) & {P}^{*} ( x )\end{matrix} ] = {R}_{Z} ( α ) {R}_{Y} ( {θ}_{0} ) {R}_{Z} ( {ϕ}_{0} ) {\prod }_{l = 1}^{L} {R}_{Z} ( x ) {R}_{Y} ( {θ}_{l} ) {R}_{Z} ( {ϕ}_{l} ) .$$

Here, Q*(x) is the complex conjugate of Q(x), and P*(x) is the complex conjugate of P(x). Finally, the optimal parameter values \hat{α}, \hat{θ} and \hat{ϕ} are output.

In practical applications, any trigonometric polynomial that can approximate the objective function with a certain precision may also be used to optimize and obtain the optimal parameter values of the target adjustable parameters.

Part II (Program 2) is mainly used to calculate the k-order trace of the first quantum state, and this Program 2 is a subprogram that will be called by the main program.

It can be understood that, in practical applications, Program 2 may be operated in a classical computing device or in a quantum computing device without considering the calculation cost, which is not specifically limited in the solution of the present disclosure.

Specifically, the specific steps of Program 2 include the followings.

In step 21, extend the preset parameterized quantum circuit to a target quantum circuit with n+1 qubits, to enable the target quantum circuit to estimate the k-order trace corresponding to the first quantum state. In this example, the target quantum circuit shown in FIG. 4(c) is taken as an example. The newly added or extended n qubits are the main qubits, and the n main qubits may be collectively referred to as the main register.

That is to say, the target quantum circuit includes an auxiliary register and a main register; where the auxiliary register includes one auxiliary qubit, and the main register includes n main qubits. Here, n is determined based on the quantity of qubits corresponding to the first quantum state (that is, the quantity of qubits contained in the first quantum system), for example, n is the quantity of qubits contained in the first quantum system. In other words, the quantity of main qubits contained in the main register is the same as the quantity of qubits contained in the first quantum system.

Specifically, the target quantum circuit is: taking a qubit in the preset parameterized quantum circuit as the auxiliary register, and expanding to obtain the main register containing n qubits; and at the same time, replacing a first target revolving gate acting on the auxiliary register in the preset parameterized quantum circuit by the first controlled unitary gate, and replacing a second target revolving gate acting on the auxiliary register in the preset parameterized quantum circuit by the second controlled unitary gate.

Further, the first target revolving gate and the second target revolving gate are target revolving gates in different training layers; that is, the target revolving gates in different training layers in the preset parameterized quantum circuit are replaced by different controlled unitary gates, for example, the target revolving gate (for ease of description, which may be called the first target revolving gate) in one training layer in the preset parameterized quantum circuit is replaced by the first controlled unitary gate, and at the same time, the target revolving gate (for ease of description, which may be called the second target revolving gate) in another training layer in the preset parameterized quantum circuit is replaced by the second controlled unitary gate, thus obtaining the target quantum circuit.

It can be understood that the target quantum circuit is obtained by extending the preset parameterized quantum circuit, and is obtained by replacing two target revolving gates of different layers in the preset parameterized quantum circuit by the first controlled unitary gate and the second controlled unitary gate respectively, so the target quantum circuit contains at most L/2 layers in the case where the preset parameterized quantum circuit contains L layers.

Specifically, the preset parameterized quantum circuit is extended to the main register containing n main qubits, and at the same time, the target revolving gates in two adjacent training layers of the preset parameterized quantum circuit are replaced by the first controlled unitary gate and the second controlled unitary gate respectively. For example, the target revolving gate of the (i+1)-th training layer is replaced by the first controlled unitary gate, and the target revolving gate of the i-th training layer is replaced by the second controlled unitary gate, to obtain a structural schematic diagram of the

$$⌈ \frac{i}{2} ⌉ - th$$

layer in the target quantum circuit as shown in FIG. 4(a). The

$$⌈ \frac{i}{2} ⌉ - th$$

layer, according to the action order of quantum gates, specifically includes a first revolving gate R_{Z}(ϕᵢ₊₁) with a rotation angle ϕᵢ₊₁ being an angle corresponding to the z-axis, a second revolving gate R_{Y}(θᵢ₊₁) with a rotation angle θᵢ₊₁ being an angle corresponding to the y-axis, a first controlled unitary gate, a first revolving gate R_{Z}(ϕᵢ) with a rotation angle ϕᵢ being an angle corresponding to the z-axis, a second revolving gate R_{Y}(θᵢ) with a rotation angle θᵢ being an angle corresponding to the y-axis, and a second controlled unitary gate.

Here, for the convenience of description, the relevant parameterized quantum circuit acting on the auxiliary qubit in the target quantum circuit may be referred to as a sub-circuit of the target quantum circuit. It can be understood that the sub-circuit also contains L/2 layers. Further, as shown in FIG. 4(a), each layer in this sub-circuit contains target adjustable parameters; for example, the

$$⌈ \frac{i}{2} ⌉ - th$$

layer in this sub-circuit contains a first revolving gate R_{Z}(ϕᵢ₊₁) with a rotation angle ϕᵢ₊₁ being an angle corresponding to the z-axis, a second revolving gate R_{Y}(θᵢ₊₁) with a rotation angle θᵢ₊₁ being an angle corresponding to the y-axis, a first revolving gate R_{Z}(ϕᵢ) with a rotation angle ϕᵢ being an angle corresponding to the z-axis, and a second revolving gate R_{Y}(θᵢ) with a rotation angle θᵢ being an angle corresponding to the y-axis.

Here, the rotation angles ϕᵢ₊₁, θᵢ₊₁, ϕᵢ and θᵢ are target adjustable parameters of the current layer.

It can be understood that the target quantum circuit is obtained by extending the preset parameterized quantum circuit, so the target quantum circuit, similar to the preset parameterized quantum circuit, further includes other revolving gates after the L/2 layers.

Specifically, in one example, the target quantum circuit further includes a third revolving gate R_{Z}(ϕ₀) and a fourth revolving gate R_{Y}(θ₀) as shown in FIG. 3(b) after the L/2 layers. Here, the rotation angles ϕ₀ and θ₀ are both target adjustable parameters.

Alternatively, in another example, the target quantum circuit further includes a third revolving gate R_{Z}(ϕ₀), a fourth revolving gate R_{Y}(θ₀) and a fifth revolving gate R_{Z}(α) as shown in FIG. 3(c) after the L/2 layers. Here, the rotation angles ϕ₀ and θ₀ are both target adjustable parameters, while the rotation angle α is a fixed value. Alternatively, the rotation angles ϕ₀, θ₀ and a are all target adjustable parameters. The specific content can refer to the above description, which will not be repeated here.

In step 22, input an error tolerance value ϵ>0 and the order k, and set the first input state of the auxiliary register to the preset initial state, such as |0 [symbol] or |1 [symbol] ; and set the second input state of the main register to the first quantum state ρ (that is, ρ_{A} mentioned above). Further, in a specific example, when the quantum state of the auxiliary register is |0 [symbol] ,

the controlled unitary gate U^{†} with a hollow core (that is, the second controlled unitary gate) in the target quantum circuit is activated. When the quantum state of the auxiliary register is |1 [symbol] , the controlled unitary gate U with a solid core (that is, the first controlled unitary gate) is activated. That is to say, in practical applications, when the current quantum state of the auxiliary register is determined, the first controlled unitary gate works or the second controlled unitary gate works, instead of both.

In step 23, set e₀:=1, and R₁:=1.

In step 24, input the error tolerance value e and the order k (in the case of being greater than or equal to 2) to the “Program 1”, and operate the “Program 1” to obtain the output optimal parameter values (that is, target parameter values): \hat{α}, \hat{θ} and \hat{ϕ}.

Here, \hat{θ}={\hat{θ}₀, \hat{θ}₁, . . . , \hat{θ}ᵢ, . . . , \hat{θ}_{L}}, and \hat{ϕ}={\hat{ϕ}₀, \hat{ϕ}₁, . . . , \hat{ϕ}ᵢ, . . . , \hat{ϕ}_{L}}.

In step 25, as shown in FIG. 4(c), input the optimal parameter values \hat{α}, \hat{θ} and \hat{ϕ}; and apply the unitary operator U to the target quantum circuit on n+1 qubits, that is, apply the first controlled unitary gate equivalent to U (U:=e^{iρ}) and the second controlled unitary gate equivalent to U^{†} (U^{†}:=e^{-iρ}) to the target quantum circuit on n+1 qubits.

Here, the unitary operator U is obtained based on the first quantum state ρ. At this time, the first controlled unitary gate U is the equivalent circuit of e^{iρ}, and the second controlled unitary gate U^{†} is the equivalent circuit of e^{-iρ}.

In step 26, obtain an expected value of the target quantum circuit for the observable quantity Z⊗I, denoted as [symbol] Z [symbol] .

Here, the observable quantity Z⊗I specifically refers to the operation of a measurement operator Z on the auxiliary register, while the remaining qubits (that is, the main register) are not operated on, where I represents an identity matrix. Specifically, the way to obtain the expected value is as follows.
(a) Set the quantity of quantum measurements as

$$N = O ( \frac{1}{{ϵ}^{2}} ) .$$

(b) Use the Pauli Z operator to measure the auxiliary register, and count the quantities of occurrences of 0 and 1.
(c) Calculate the expected value of the observable quantity Z⊗I based on the statistical result:

$$〈 Z 〉 := \frac{Total quantity of occurences of 0 - Total quantity of occurrences of 1}{N} .$$

In step 27, obtain the k-order trace Rₖ of the first quantum state based on the expected value [symbol] Z [symbol] , namely: Rₖ:= [symbol] Z [symbol] ·2π^{k-1}.

In a specific example, the objective function simulated in the solution of the present disclosure is

$$f ( x ) = \frac{{x}^{k}}{2 {π}^{k}} .$$

It should be noted that, in this example, the simulated objective function ƒ(x) may be transformed accordingly, such as

$$f ( x ) = \frac{{x}^{k}}{3 {π}^{k}} , f ( x ) = \frac{{x}^{k}}{4 {π}^{k}} ,$$

etc. At this time, they can be collectively referred to as

$$f ( x ) = \frac{{x}^{k}}{c {π}^{k}} ,$$

where c is a real number greater than or equal to 1. Alternatively, other transformations may be performed on the above objective function

$$\frac{{x}^{k}}{2 {π}^{k}} ,$$

as long as the normalization requirement can be satisfied, that is, when the value of x is in [−π, π], the value of ƒ(x) is in [−1, 1].

It should be noted that the objective function ƒ(x) in this example may also be specifically

$${( {cos}^{2} x )}^{\frac{k}{2}} .$$

At this time, the target quantum circuit extended based on the preset parameterized quantum circuit may have the structure as shown in FIG. 4(e) or 4(f); and at this time, the input state of the first group of qubits is the preset initial state, such as |0 [symbol] or |1 [symbol] , the input state of the second group of qubits is also the preset initial state, such as |0 [symbol] or |1 [symbol] , and the input state of the third group of qubits is the first quantum state ρ.

Part III (Program 3) is a main program and is mainly used to estimate the entanglement spectroscopy corresponding to the first quantum state.

It can be understood that, in practical applications, Program 3 may be operated in a classical computing device or in a quantum computing device without considering the calculation cost, which is not specifically limited in the solution of the present disclosure.

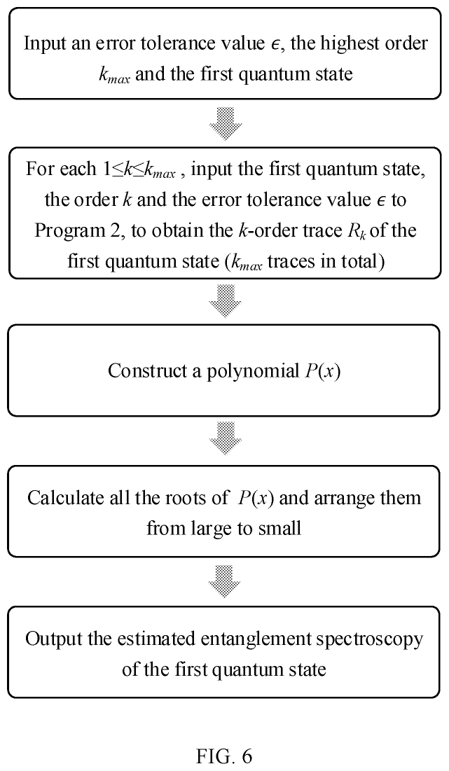

Specifically, as shown in FIG. 6, the specific steps of the main program include the followings.

In step 31, input a reduced quantum state (i.e., first quantum state) ρ_{A} with size of n qubits, the highest order kₘₐₓ, and an error tolerance value ε>0.

In step 32, for each 1≤k≤kₘₐₓ, input the first quantum state ρ_{A}, the order k and the error tolerance value ε to Program 2, and operate Program 2 to obtain the output k-order trace Rₖ of the first quantum state (kₘₐₓ traces in total).

In step 33, calculate eₖ according to the k-order trace Rₖ of the first quantum state, to obtain e₁ to eₖ_{ₘₐₓ}; and construct the following polynomial P(x):

$$P ( x ) = {\sum }_{m = 0}^{{k}_{max}} {( - 1 )}^{{k}_{max} - m} {e}_{{k}_{max} - m} {x}^{m} .$$

In step 34, calculate all the roots of P(x) and arrange them from large to small, where all the roots of P(x) are the feature values of the first quantum state ρ_{A}, denoted as {λₖ}ₖ₌1^{k}ₘₐₓ, that is, the entanglement spectroscopy of the total quantum system.

Here, all roots of P(x) are obtained by calculating all feature values of a matrix with size of kₘₐₓ×kₘₐₓ. In practical applications, the algorithm for finding polynomial roots is not unique. For example, the Laguerre's method or Aberth method may also be used to find polynomial roots, which is not limited in the solution of the present disclosure. An appropriate implementation manner may be selected based on factors such as actual application scenario and hardware environment.

In step 35, output the estimated entanglement spectroscopy of the first quantum state ρ_{A}, namely {λₖ}ₖ₌1^{k}ₘₐₓ.

### Extended Solution

Since the simulated logarithmic function is only defined in (0, +∞) but not in the interval of (−∞,0], the present disclosure can expand the definition domain of the logarithmic function through piecewise functions, so as to define an even function as the objective function in Program 1. For example, all the first revolving gates R_{Z}(ϕᵢ) in the target quantum circuit shown in FIG. 3(a) and the third revolving gate R_{Z}(ϕ₀) shown in FIG. 3(c) in the “Program 1” and “Program 2” may be deleted to obtain the structure as shown in FIGS. 3(d) and 3(e) or FIGS. 3(d) and 3(f), to simulate an even function, further reducing the circuit depth by half while achieving the same effect.

### Case Presentation

The solution of the present disclosure is verified by specific cases.

In this example, the Bell State

$${{{{\vert ψ 〉 = \frac{2}{\sqrt{5}} \vert 0 〉}_{A} \vert 0 〉}_{B} + \frac{1}{\sqrt{5}} \vert 1 〉}_{A} \vert 1 〉}_{B}$$

is selected as the bipartite quantum state on the first quantum system A (which is a single-qubit quantum system) and the second quantum system B (which is a single-qubit quantum system). Specifically, the reduced quantum state (that is, the first quantum state) of the bipartite quantum state |ψ [symbol] on the first quantum system A is:

$${ρ}_{A} = \frac{1}{5} [ \begin{matrix}4 & 0 \\ 0 & 1\end{matrix} ] .$$

Considering a simple case, kₘₐₓ=2 is set, and the target quantum circuit shown in FIG. 4(c) is used. In particular, L=50 is set in this example. At this time, the goal of the experiment is to estimate the feature value of ρ_{A}.

Here, the estimated values based on the numerical simulation of the solution of the present disclosure are 0.17609249 and 0.82390751, and the errors from the actual values of 0.2 and 0.8 are both less than 0.03.

To sum up, the solution of the present disclosure can be adapted to the near-term quantum computer, and has the following features.
1. The solution of the present disclosure can estimate the quantum entanglement spectroscopy by using only one auxiliary qubit, greatly reducing the circuit width required for estimating the entanglement spectroscopy. For example, for the bipartite quantum state |ψ [symbol] with dimension D=2ⁿ and the order k, the width of the quantum circuit required by the solution of the present disclosure may be n+1. Here, the extremely low circuit width means that the solution of the present disclosure requires an extremely small quantity of qubits to operate, thus greatly improving the practicability on the medium-scale quantum device with noise and having strong scalability.
2. The solution of the present disclosure can significantly reduce errors caused by measurement, and have both accuracy and convenience.
3. The solution of the present disclosure can use a single auxiliary qubit to control the unitary operator, thus reducing the required quantum computing resources, and also enhancing the feasibility of estimating the entanglement spectroscopy using the medium-scale quantum device with noise.
4. The solution of the present disclosure also has practicability, high efficiency, determinacy, scalability, innovation and reusability; and specifically, the practicality means that the solution of the present disclosure requires the low width of the circuit and can be implemented on the near-term quantum computer; the high efficiency means that the solution of the present disclosure can construct a quantum circuit with low consumption and output an estimated value with low consumption; the determinacy means that the solution of the present disclosure can obtain the estimated value satisfying the accuracy requirement with a very high probability; the scalability means that the solution of the present disclosure can be applied to the entanglement spectroscopy estimation for large-scale quantum states; and the innovation means that the solution of the present disclosure provides a novel quantum circuit to realize the estimation of the n-order trace of the quantum state. The reusability means that the optimal parameter value of the target adjustable parameter can be reused, and is only related to the order but not the dimension of the quantum state. For example, for a determined k, the optimal parameter value obtained by Program 1 can be used repeatedly to calculate the k-order traces of different quantum states.

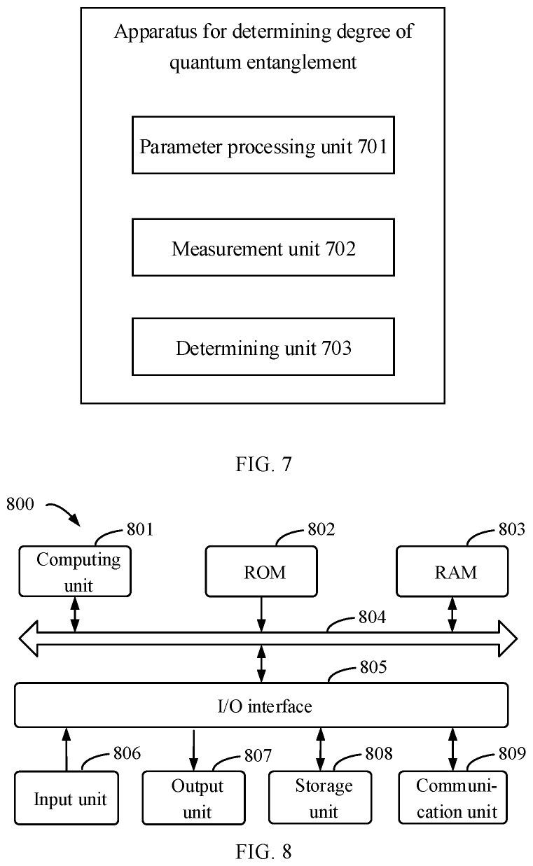

The solution of the present disclosure further provides an apparatus for determining a degree of quantum entanglement, as shown in FIG. 7, including: a parameter processing unit 701 configured to determine a target parameter value of a target adjustable parameter in a sub-circuit of a target quantum circuit; where the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; a value of k is related to the quantity of qubits corresponding to the first quantum state; the target controlled unitary gate includes a first controlled unitary gate equivalent to a unitary operator U, and a second controlled unitary gate equivalent to a conjugate transpose U^{†} of the unitary operator U; the unitary operator is a unitary operator corresponding to a first quantum system; and the first quantum system is a system corresponding to the first quantum state; a measurement unit 702 configured to obtain state information of the auxiliary register in the target quantum circuit, in a case of the target adjustable parameter has the target parameter value, a first input state of the auxiliary register is a preset initial state, and a second input state of the main register includes at least the first quantum state; and a determining unit 703 configured to estimate the k-order trace of the first quantum state under the first error condition based on the state information of the auxiliary register; and determine a degree of entanglement corresponding to the first quantum state based on at least the k-order trace of the first quantum state.

In a specific example of the solution of the present disclosure, the determining unit 703 is further configured to: obtain (kₘₐₓ−1) traces, in a case of the value of k is 2 to a preset maximum order k^{max}; where the (kₘₐₓ−1) traces include 2-order trace to k^{max}-order trace; and kₘₐₓ is a positive integer greater than k; and estimate an entanglement spectroscopy corresponding to the first quantum state based on the 2-order trace to Kₘₐₓ-order trace, where the entanglement spectroscopy corresponding to the first quantum state is used to measure a degree of entanglement of a total quantum system corresponding to the first quantum system.

In a specific example of the solution of the present disclosure, the parameter processing unit 701 is specifically configured to: take a target parameter value of the target adjustable parameter in a preset parameterized quantum circuit that has been trained as the target parameter value of the target adjustable parameter in the sub-circuit; where the preset parameterized quantum circuit that has been trained is used to simulate an objective function ƒ(x); the objective function ƒ(x) is used to characterize a correlation between an order k and an independent variable x; the order k is less than a dimension d of the first quantum state; and the dimension D the first quantum state is related to the quantity of qubits corresponding to the first quantum state; where the target quantum circuit is obtained by: taking a qubit in the preset parameterized quantum circuit as the auxiliary register, expanding the preset parameterized quantum circuit to obtain the main register, replacing a first target revolving gate acting on the auxiliary register in the preset parameterized quantum circuit by the first controlled unitary gate, and replacing a second target revolving gate acting on the auxiliary register in the preset parameterized quantum circuit by the second controlled unitary gate; where a first rotation parameter of the first target revolving gate and a second rotation parameter of the second target revolving gate are both the independent variable x of the objective function ƒ(x); and the sub-circuit contains at least some circuits in the preset parameterized quantum circuit except the first target revolving gate and the second target revolving gate.

In a specific example of the solution of the present disclosure, the parameter processing unit 701 is further configured to: obtain an actual output result yⱼ of the preset parameterized quantum circuit to obtain N actual output results yⱼ, in a case of a value of a rotation parameter x of the preset parameterized quantum circuit is any data point xⱼ among N data points; where the actual output result yⱼ is an output result of the preset parameterized quantum circuit with the target adjustable parameter in the preset parameterized quantum circuit at a current parameter value; N is a positive integer greater than or equal to 1, and j=1, 2, . . . , N; and the rotation parameter x includes the first rotation parameter and the second rotation parameter; and take the current parameter value of the target adjustable parameter as the target parameter value of the target adjustable parameter in the preset parameterized quantum circuit that has been trained, in a case of it is determined that an iteration termination condition is satisfied; where the iteration termination condition includes at least one of: determining that a loss value of a preset loss function satisfies a convergence condition based on the N actual output results yⱼ and N target output results ŷⱼ; where the target output result is ŷⱼ=ƒ(xⱼ); or a current quantity of iterations reaches a preset number.

In a specific example of the solution of the present disclosure, the parameter processing unit 701 is further configured to: perform the following operations iteratively in a case of it is determined that the iteration termination condition is not satisfied, until the iteration termination condition is satisfied: adjust a parameter value of the target adjustable parameter; and obtain the actual output result yⱼ of the preset parameterized quantum circuit to obtain the N actual output results yⱼ, in the case of the value of the rotation parameter x of the preset parameterized quantum circuit is any data point x among the N data points.

In a specific example of the solution of the present disclosure, the preset parameterized quantum circuit includes L training layers; L is an even number greater than or equal to 2, and a value of L is related to the first error condition; at least two of the L training layers include: a target revolving gate, where the rotation parameter x is used to perform a revolving operation on a first angle; and the first target revolving gate and second target revolving gate are target revolving gates in different training layers; a first revolving gate for performing a revolving operation on a second angle and acting on a qubit in the preset parameterized quantum circuit; and a second revolving gate for performing a revolving operation on a third angle and acting on a qubit in the preset parameterized quantum circuit; where a rotation angle ϕ of the first revolving gate and a rotation angle θ of the second revolving gate are the target adjustable parameters; or at least two of the L training layers include: a target revolving gate, where the rotation parameter x is used to perform a revolving operation on a first angle; and the first target revolving gate and second target revolving gate are target revolving gates in different training layers; and a second revolving gate for performing a revolving operation on a third angle and acting on a qubit in the preset parameterized quantum circuit; where a rotation angle θ of the second revolving gate is the target adjustable parameter.

In a specific example of the solution of the present disclosure, at least one of following conditions is further satisfied: the first angle is an angle corresponding to a z-axis; the second angle is an angle corresponding to the z-axis; or the third angle is an angle corresponding to a y-axis.

In a specific example of the solution of the present disclosure, an action order of revolving gates is: the first revolving gate, the second revolving gate, the target revolving gate, in a case of any of the L training layers contains the target revolving gate, the first revolving gate and the second revolving gate; or an action order of revolving gates is: the second revolving gate, the target revolving gate, in a case of any of the L training layers contains the target revolving gate and the second revolving gate.

In a specific example of the solution of the present disclosure, other revolving gates are further included after the L training layers of the preset parameterized quantum circuit.

In a specific example of the solution of the present disclosure, the target quantum circuit contains M layers, and M is a positive integer greater than or equal to 1 and less than or equal to L/2; and at least one of the M layers is obtained by: replacing a first target revolving gate of a first training layer among two training layers by the first controlled unitary gate, and replacing a second target revolving gate of a second training layer among the two training layers by the second controlled unitary gate; where the two training layers are any two of the L training layers.

In a specific example of the solution of the present disclosure, the two training layers are any adjacent two of the L training layers.

In a specific example of the solution of the present disclosure, an equivalent circuit of the first controlled unitary gate in the target quantum circuit is an equivalent circuit of the unitary operator U:=e^{iρ}, and an equivalent circuit of the second controlled unitary gate in the target quantum circuit is an equivalent circuit of the conjugate transpose U^{†}:=e^{-iρ} of the unitary operator U, in a case of the unitary operator U is obtained based on the first quantum system; where ρ represents the first quantum state; or an equivalent circuit of the first controlled unitary gate in the target quantum circuit is an equivalent circuit of the unitary operator U:=RE, and an equivalent circuit of the second controlled unitary gate in the target quantum circuit is an equivalent circuit of the conjugate transpose U^{†}:=(RE)^{†} of the unitary operator U, in a case of the unitary operator U is obtained based on the total quantum system corresponding to the first quantum system; where E represents block encoding of the first quantum state; and R represents a Reflector constructed based on the total quantum system.

For the description of specific functions and examples of the units of the apparatus of the embodiments of the present disclosure, reference may be made to the relevant description of the corresponding steps in the above-mentioned method embodiments, and details are not repeated here.

The solution of the present disclosure further provides a non-transitory computer-readable storage medium storing a computer instruction thereon, and the computer instruction causes at least one quantum processing unit to execute the above method applied to a quantum computing device, when executed by the at least one quantum processing unit.

The solution of the present disclosure further provides a computer program product including a computer program, and the computer program implements the method applied to a quantum computing device, when executed by at least one quantum processing unit.

The solution of the present disclosure further provides a computing device, including: at least one quantum processing unit (QPU); and a memory coupled to the at least one QPU and configured to store an executable instruction, where the instruction, when executed by the at least one quantum processing unit, enables the at least one quantum processing unit to execute the method applied to a quantum computing device.

It can be understood that the Quantum Processing Unit (QPU) used in the solution of the present disclosure may also be referred to as a quantum processor or a quantum chip, and may involve a physical chip including a plurality of qubits interconnected in a specific way.

Moreover, it can be understood that the qubit described in the solution of the present disclosure may refer to a basic information unit of a quantum computing device. Qubits are included in the QPU and generalize the concept of classical digital bits.

Further, according to the embodiments of the present disclosure, the present disclosure further provides a computing device, a readable storage medium and a computer program product.

FIG. 8 shows a schematic block diagram of an exemplary computing device 800 that may be used to implement the embodiments of the present disclosure. The computing device is intended to represent various forms of digital computers, such as a laptop, a desktop, a workstation, a personal digital assistant, a server, a blade server, a mainframe computer, and other suitable computers. The computing device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for an operation of device 800 may also be stored in the RAM 803. The computing unit 801, the ROM 802 and the RAM 803 are connected to each other through a bus 804. The input/output (I/O) interface 805 is also connected to the bus 804.

A plurality of components in the device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AD computing chips, various computing units that run machine learning model algorithms, a Digital Signal Processor (DSP), and any appropriate processors, controllers, microcontrollers, or the like. The computing unit 801 performs various methods and processing described above, such as the method for determining the degree of quantum entanglement. For example, in some implementations, the method for determining the degree of quantum entanglement may be implemented as a computer software program tangibly contained in a computer-readable medium, such as the storage unit 808. In some implementations, a part or all of the computer program may be loaded and/or installed on the device 800 via the ROM 802 and/or the communication unit 809. When the computer program is loaded into the RAM 803 and executed by the computing unit 801, one or more steps of the method for determining the degree of quantum entanglement described above may be performed. Alternatively, in other implementations, the computing unit 801 may be configured to perform the method for determining the degree of quantum entanglement by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method for determining a degree of quantum entanglement, comprising:
determining a target parameter value of a target adjustable parameter in a sub-circuit of a target quantum circuit; wherein the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; a value of k is related to a quantity of qubits corresponding to the first quantum state; the target controlled unitary gate comprises a first controlled unitary gate equivalent to a unitary operator U, and a second controlled unitary gate equivalent to a conjugate transpose U^{†} of the unitary operator U; the unitary operator is corresponding to a first quantum system; and the first quantum system is corresponding to the first quantum state;
obtaining state information of the auxiliary register in the target quantum circuit, in a case of the target adjustable parameter has the target parameter value, a first input state of the auxiliary register is a preset initial state, and a second input state of the main register comprises at least the first quantum state;
estimating the k-order trace of the first quantum state under the first error condition based on the state information of the auxiliary register; and
determining a degree of entanglement corresponding to the first quantum state based on at least the k-order trace of the first quantum state.

2. The method of claim 1, further comprising:
obtaining (kₘₐₓ−1) traces, in a case of the value of k is 2 to a preset maximum order kₘₐₓ;
wherein the (kₘₐₓ−1) traces comprise 2-order trace to kₘₐₓ-order trace; and kₘₐₓ is a positive integer greater than k;
wherein determining the degree of entanglement corresponding to the first quantum state based on at least the k-order trace of the first quantum state, comprises:
estimating an entanglement spectroscopy corresponding to the first quantum state based on the 2-order trace to kₘₐₓ-order trace, wherein the entanglement spectroscopy corresponding to the first quantum state is used to measure a degree of entanglement of a total quantum system corresponding to the first quantum system.

3. The method of claim 1, wherein determining the target parameter value of the target adjustable parameter in the sub-circuit of the target quantum circuit, comprises:
taking a target parameter value of the target adjustable parameter in a preset parameterized quantum circuit that has been trained as the target parameter value of the target adjustable parameter in the sub-circuit; wherein the preset parameterized quantum circuit that has been trained is used to simulate an objective function ƒ(x); the objective function ƒ(x) is used to characterize a correlation between an order k and an independent variable x; the order k is less than a dimension D of the first quantum state; and the dimension D of the first quantum state is related to the quantity of qubits corresponding to the first quantum state;
wherein the target quantum circuit is obtained by:
taking a qubit in the preset parameterized quantum circuit as the auxiliary register;
expanding the preset parameterized quantum circuit to obtain the main register;
replacing a first target revolving gate acting on the auxiliary register in the preset parameterized quantum circuit by the first controlled unitary gate; and
replacing a second target revolving gate acting on the auxiliary register in the preset parameterized quantum circuit by the second controlled unitary gate;
wherein a first rotation parameter of the first target revolving gate and a second rotation parameter of the second target revolving gate are both the independent variable x of the objective function ƒ(x); and the sub-circuit contains at least some circuits in the preset parameterized quantum circuit except the first target revolving gate and the second target revolving gate.

4. The method of claim 3, further comprising:
obtaining an actual output result yⱼ of the preset parameterized quantum circuit to obtain N actual output results yⱼ, in a case of a value of a rotation parameter x of the preset parameterized quantum circuit is any data point xⱼ among N data points; wherein the actual output result yⱼ is an output result of the preset parameterized quantum circuit with the target adjustable parameter in the preset parameterized quantum circuit at a current parameter value; N is a positive integer greater than or equal to 1, and j=1, 2, . . . , N; and the rotation parameter x comprises the first rotation parameter and the second rotation parameter; and
taking the current parameter value of the target adjustable parameter as the target parameter value of the target adjustable parameter in the preset parameterized quantum circuit that has been trained, in a case of it is determined that an iteration termination condition is satisfied;
wherein the iteration termination condition comprises at least one of:
determining that a loss value of a preset loss function satisfies a convergence condition based on the N actual output results yⱼ and N target output results ŷⱼ; wherein each target output result is ŷⱼ=ƒ(xⱼ); or
a current quantity of iterations reaches a preset number.

5. The method of claim 4, further comprising:
performing the following operations iteratively in a case of it is determined that the iteration termination condition is not satisfied, until the iteration termination condition is satisfied:
adjusting a parameter value of the target adjustable parameter; and
obtaining the actual output result yⱼ of the preset parameterized quantum circuit to obtain the N actual output results yⱼ, in the case of the value of the rotation parameter x of the preset parameterized quantum circuit is any data point xⱼ among the N data points.

6. The method of claim 3, wherein the preset parameterized quantum circuit comprises L training layers; L is an even number greater than or equal to 2, and a value of L is related to the first error condition;
at least two of the L training layers comprise:
a target revolving gate, wherein a rotation parameter x is used to perform a revolving operation on a first angle; and the first target revolving gate and second target revolving gate are target revolving gates in different training layers;
a first revolving gate for performing a revolving operation on a second angle and acting on a qubit in the preset parameterized quantum circuit; and
a second revolving gate for performing a revolving operation on a third angle and acting on a qubit in the preset parameterized quantum circuit;
wherein a rotation angle ϕ of the first revolving gate and a rotation angle θ of the second revolving gate are target adjustable parameters.

7. The method of claim 6, wherein at least one of following conditions is further satisfied:
the first angle is an angle corresponding to a z-axis;
the second angle is an angle corresponding to the z-axis; or
the third angle is an angle corresponding to a y-axis.

8. The method of claim 6, wherein an action order of revolving gates is: the first revolving gate, the second revolving gate, the target revolving gate.

9. The method of claim 6, wherein the target quantum circuit contains M layers, and M is a positive integer greater than or equal to 1 and less than or equal to L/2; and
at least one of the M layers is obtained by:
replacing a first target revolving gate of a first training layer among two training layers by the first controlled unitary gate; and
replacing a second target revolving gate of a second training layer among the two training layers by the second controlled unitary gate;
wherein the two training layers are any two of the L training layers or any adjacent two of the L training layers.

10. The method of claim 9, wherein an equivalent circuit of the first controlled unitary gate in the target quantum circuit is an equivalent circuit of the unitary operator U:=e^{iρ}, and an equivalent circuit of the second controlled unitary gate in the target quantum circuit is an equivalent circuit of the conjugate transpose U^{†}:=e^{-iρ} of the unitary operator U, in a case of the unitary operator U is obtained based on the first quantum system; wherein ρ represents the first quantum state.

11. The method of claim 9, wherein an equivalent circuit of the first controlled unitary gate in the target quantum circuit is an equivalent circuit of the unitary operator U:=RE, and an equivalent circuit of the second controlled unitary gate in the target quantum circuit is an equivalent circuit of the conjugate transpose U^{†}:=(RE)^{†} of the unitary operator U, in a case of the unitary operator U is obtained based on a total quantum system corresponding to the first quantum system; wherein E represents block encoding of the first quantum state; and R represents a Reflector constructed based on the total quantum system.

12. The method of claim 3, wherein the preset parameterized quantum circuit comprises L training layers; L is an even number greater than or equal to 2, and a value of L is related to the first error condition;
at least two of the L training layers comprise:
a target revolving gate, wherein a rotation parameter x is used to perform a revolving operation on a first angle; and the first target revolving gate and second target revolving gate are target revolving gates in different training layers; and
a second revolving gate for performing a revolving operation on a third angle and acting on a qubit in the preset parameterized quantum circuit;
wherein a rotation angle θ of the second revolving gate is the target adjustable parameter.

13. The method of claim 12, wherein at least one of following conditions is further satisfied:
the first angle is an angle corresponding to a z-axis; or
the third angle is an angle corresponding to a y-axis.

14. The method of claim 12, wherein an action order of revolving gates is: the second revolving gate, the target revolving gate.

15. The method of claim 12, wherein the target quantum circuit contains M layers, and M is a positive integer greater than or equal to 1 and less than or equal to L/2; and
at least one of the M layers is obtained by:
replacing a first target revolving gate of a first training layer among two training layers by the first controlled unitary gate, and
replacing a second target revolving gate of a second training layer among the two training layers by the second controlled unitary gate;
wherein the two training layers are any two of the L training layers or any adjacent two of the L training layers.

16. The method of claim 15, wherein an equivalent circuit of the first controlled unitary gate in the target quantum circuit is an equivalent circuit of the unitary operator U:=e^{iρ}, and an equivalent circuit of the second controlled unitary gate in the target quantum circuit is an equivalent circuit of the conjugate transpose U^{†}:=e^{-iρ} of the unitary operator U, in a case of the unitary operator U is obtained based on the first quantum system; wherein ρ represents the first quantum state;
or
an equivalent circuit of the first controlled unitary gate in the target quantum circuit is an equivalent circuit of the unitary operator U:=RE, and an equivalent circuit of the second controlled unitary gate in the target quantum circuit is an equivalent circuit of the conjugate transpose U^{†}:=(RE)^{†} of the unitary operator U, in a case of the unitary operator U is obtained based on a total quantum system corresponding to the first quantum system; wherein E represents block encoding of the first quantum state; and R represents a Reflector constructed based on the total quantum system.

17. A computing device, comprising:
at least one quantum processing unit (QPU); and
a memory coupled to the at least one QPU and configured to store an executable instruction,
wherein the instruction, when executed by the at least one quantum processing unit, enables the at least one quantum processing unit to execute operations, comprising:
determining a target parameter value of a target adjustable parameter in a sub-circuit of a target quantum circuit; wherein the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; a value of k is related to a quantity of qubits corresponding to the first quantum state; the target controlled unitary gate comprises a first controlled unitary gate equivalent to a unitary operator U, and a second controlled unitary gate equivalent to a conjugate transpose U^{†} of the unitary operator U; the unitary operator is corresponding to a first quantum system; and the first quantum system is corresponding to the first quantum state;
obtaining state information of the auxiliary register in the target quantum circuit, in a case of the target adjustable parameter has the target parameter value, a first input state of the auxiliary register is a preset initial state, and a second input state of the main register comprises at least the first quantum state;
estimating the k-order trace of the first quantum state under the first error condition based on the state information of the auxiliary register; and
determining a degree of entanglement corresponding to the first quantum state based on at least the k-order trace of the first quantum state.

18. A computing device, comprising:
at least one processor; and
a memory connected in communication with the at least one processor;
wherein the memory stores an instruction executable by the at least one processor, and the instruction, when executed by the at least one processor, enables the at least one processor to execute the method of claim 1.

19. A non-transitory computer-readable storage medium storing a computer instruction thereon that, when executed by at least one quantum processing unit, causes the at least one quantum processing unit to execute operations, comprising:
determining a target parameter value of a target adjustable parameter in a sub-circuit of a target quantum circuit; wherein the target parameter value satisfies a first error condition; the target quantum circuit contains an auxiliary register and a main register, and the sub-circuit acts on the auxiliary register; the target quantum circuit further contains a target controlled unitary gate that is controlled by the auxiliary register and acts on the main register, and the target controlled unitary gate is configured to estimate a k-order trace corresponding to a first quantum state; a value of k is related to a quantity of qubits corresponding to the first quantum state; the target controlled unitary gate comprises a first controlled unitary gate equivalent to a unitary operator U, and a second controlled unitary gate equivalent to a conjugate transpose U^{†} of the unitary operator U; the unitary operator is corresponding to a first quantum system; and the first quantum system is corresponding to the first quantum state;
obtaining state information of the auxiliary register in the target quantum circuit, in a case of the target adjustable parameter has the target parameter value, a first input state of the auxiliary register is a preset initial state, and a second input state of the main register comprises at least the first quantum state;
estimating the k-order trace of the first quantum state under the first error condition based on the state information of the auxiliary register; and
determining a degree of entanglement corresponding to the first quantum state based on at least the k-order trace of the first quantum state.

20. A non-transitory computer-readable storage medium storing a computer instruction thereon, wherein the computer instruction is used to cause a computer to execute the method of claim 1.
